(19) United States
(12) Patent Application Publication
(10) Pub. No.: US 2004/0266650 A1
(43) Pub. Date: Dec. 30, 2004

(54) Washing and/or cleaning article

(76) Inventors: Alexander Lambotte, Dusseldorf (DE); Jacques Breyer, Heusden (BE); Carlos Malet, Llobregat (ES); Franz-Josef Carduck, Haan (DE)

Correspondence Address: WOODCOCK WASHBURN LLP, ONE LIBERTY PLACE, 46TH FLOOR, PHILADELPHIA, PA, 19103, US

(21) Appl. No.: 10/861,131

(22) Filed: Jun. 4, 2004

Related U.S. Application Data
(63) Continuation of application No. PCT/EP02/13125, filed on Nov. 22, 2002.

(30) Foreign Application Priority Data
Dec. 4, 2001 (DE) 101 59 499.2

(51) Int. Cl. C11D 17/00

(52) U.S. Cl. 510/438

(57) ABSTRACT

A washing and/or cleaning article which is reversibly flexible, shear and compression elastic, with at least one layer comprising at least one treatment, washing or cleaning active substance and at least one binder. The layer(s) is/are arranged on a support or in a sandwich manner between two supports. The above offers a range of advantages, notable ease of handling, avoidance of skin contact with the substance(s) and an optimized washing performance based on the serial release of the treatment, washing and/or cleanng active substances.

### CROSS REFERENCE TO RELATED APPLICATIONS

This application is a continuation of PCT/EP02/13125, filed Nov. 22, 2002, which claims the benefit of DE 101 59 499.2 filed Dec. 4, 2001.

### FIELD OF INVENTION

The present invention relates to washing and/or cleaning articles in solid form, comprising one or more layers, especially washing and/or cleaning articles in sandwich form, to a process for their production and to their use as laundry detergents.

### BACKGROUND

A recurring problem in the cleaning of objects with the aid of water and liquid or solid detergents is the accompanying portioning. Especially in the case of laundering, the filling of the washing machine with detergent is often not optimal for the user, as the required amount of solid or liquid detergent initially has to be measured and subsequently transferred to the usually very narrow, inaccessible laundry detergent receptacle of the washing machine. This usually has the consequence that some of the laundry detergent is spilt, which is messy and leads to undesired contact of the user with the laundry detergent.

In addition, there are many households, especially in rental properties, which have to make use of a communal washing machine, so that a disadvantage is that one or even several usually heavy laundry detergent packages, fabric softener bottles, etc. have to be carried through the house. In this context, it is not only the carrying, but also generally the fact that several separately packed laundry detergents and laundry after treatment agents such as fabric softeners are required that constitute an impression of low user-friendliness.

Moreover, there has for some time been a need to provide laundry detergents and cleaning compositions whose washing, care and/or cleaning ingredients are each released at the desired time at the point of use in an optimized washing process. In the prior art, the care, washing and/or cleaning substance(s) present in the laundry detergents and cleaning compositions are used in excess or added to the cleaning process.

For example, laundry detergents and cleaning compositions are described in which the washing substances are applied to supports. Such cleaning compositions frequently consist of a single support, to which washing substances are applied or which is impregnated with them. Such supported cleaning compositions are not rigid, but rather soft, i.e. not dimensionally stable, and, on contact with the user, they release perceptible amounts of cleaning composition substances, so that manual handling results in a very unpleasant feel on the hands of the user. Especially in the case of washing substances, skin contact may induce skin irritation. Moreover, in the case of these known laundry detergents and cleaning compositions, release of care, cleaning and/or washing substance at different times and conditions such as temperature and pH during the cleaning process is not possible. Moreover, concentrated release of equal or different amounts of washing substance at certain times during the washing or cleaning process is not possible.

The patents U.S. Pat. No. 4,814,099, U.S. Pat. No. 4,919,835, U.S. Pat. No. 4,931,200 and U.S. Pat. No. 5,030,375, describe, for example, laundry detergent sheets in which a water-insoluble nonwoven support is saturated successively with different solutions of washing substances and is in some cases coated with a layer of solid constituents. As before, the user comes into contact with the laundry detergent. In addition, release offset in time is not disclosed.

In addition, textile laundry detergent and cleaning composition supports such as sheets and the like have the disadvantage that they have virtually no dimensional stability, if any, and therefore fold together readily during the washing or cleaning process, so that their external surface area is considerably reduced, so that the substance release is hindered and proceeds in an uncontrolled manner.

There is therefore a need for a dimensionally stable, solid, bendable washing and/or cleaning article which ensures simple handling, virtually no, if any, release of cleaning composition substances on contact with the skin, ensures release of washing or cleaning substances at different times and in concentrated doses during the cleaning process, and/or can be used simultaneously with the article to be cleaned directly at the location of cleaning.

### SUMMARY

It is an object of the present invention to provide washing and/or cleaning articles which overcome the aforementioned disadvantages of the prior art. It is a particular object of the present invention to provide washing and/or cleaning articles which have the cleaning action of conventional laundry detergents or even exceed it, but at the same time do not release any noticeable amounts of cleaning composition substances on contact with the skin and ensure release of the washing or cleaning substances at different times during the cleaning process.

It is still a further object of the present invention to provide a production process for such washing and/or cleaning articles.

The achievement of the objects mentioned is described in the independent substance, process and use claims.

Advantageous embodiments of the present invention are evident by combination of the independent claims with the features of the dependent subclaims.

### DETAILED DESCRIPTION

The object of the present invention is achieved by a dimensionally stable washing and/or cleaning article in solid form which is bendable and/or has high rebound elasticity, and comprises at least one layer which has at least one care, washing and/or cleaning substance, the layer(s) being disposed on a support or in a sandwich-like manner between two supports.

In a preferred embodiment of the present invention, the washing and/or cleaning article has at least one layer and one support.

The inventive washing and/or cleaning article has a modulus of elasticity at 20° C. of ≧0.01 MPa and ≦1000 MPa, preferably ≧0.1 MPa, preferentially ≧100 MPa.

In the context of the present invention, the term “washing and/or cleaning and/or care substance” refers to formulations of all conceivable substances relevant in connection with a washing, cleaning and/or care operation. In the case of laundry detergent and cleaning compositions, these are primarily the actual detergents with their individual components which are described in more detail in the further course of the description. These include active substances such as surfactants (anionic, nonionic, cationic and amphoteric surfactants), builder substances (inorganic and organic builder substances), bleaches (for example peroxo bleaches and chlorine bleaches), bleach activators, bleach stabilizers, bleach catalysts, enzymes, special polymers (for example those having cobuilder properties), graying inhibitors, dyes and fragrances (perfumes), without the term being restricted to these substance groups.

However, the term “washing and/or cleaning substances” also refers to washing assistants and cleaning assistants including after-rinsing assistants. Examples of these are optical brighteners, UV protection substances, soil repellents, i.e. polymers which counteract resoiling of fibers or other surfaces. Care compositions such as laundry treatment compositions, especially fabric softeners or fibercare compositions are also regarded in accordance with the invention as washing and/or as cleaning and/or as care substances.

In the context of this invention, dimensionally stable and bendable washing and/or cleaning articles especially also include elastic washing and/or cleaning articles.

The term “elastic washing and/or cleaning articles” means in particular that the washing and/or cleaning article comprising the care, washing and/or cleaning substance has intrinsic dimensional stability which enables it to have a fracture- and/or pressure-stable, noncollapsing structure under customary conditions of production, of storage, of transport and of handling by the consumer.

In this regard, the washing and/or cleaning articles-used in accordance with the invention differ fundamentally from films, textile supports or “pouches”, as are likewise used to provide laundry detergents, cleaning compositions or care compositions. Their structure collapses even at a pressure which is only slightly above atmospheric pressure. However, the inventive bendable, preferably elastic, washing and/or cleaning articles also differ in a similar manner from coatings (applied subsequently to support) and tablets. When bent, laundry detergent and cleaning composition tablets would disintegrate immediately.

Thus, in contrast to a preferred embodiment of the present invention, impregnated nonwovens, pouches and films are not dimensionally stable and collapse when stressed vertically only on one side edge. In the case of tablets, stress leads to breakage of the tablet.

The bending behavior of the washing and/or cleaning article of the present invention is designed in such a way that, when a critical load is exceeded, it becomes unstable in the case of vertical stress on the beam axis (=at right angles with the longest axis) (test method=Euler bending case). Depending on clamping, exceedance of the critical load results in defined bending lines. Impregnated nonwovens, pouches, sheets (see EP1048722A) are not dimensionally stable and “collapse” together in the case of vertical clamping. In contrast, in the case of tablets, stress does not lead to bending along the beam axis but rather to fracture of the tablet.

The inventive washing and/or cleaning articles thus constitute a dimensionally stable, i.e. an independent, self-supporting body.

The washing and/or cleaning article can preferably be at least partly reversibly reshaped (bent) by the action of force and, after cessation of the action of force, has a certain rebound rate. High rebound rates are achieved by rigid bodies which “spring back” into the starting shape when they do not remain in the compressed state. This “spring-back” behavior is desired, since a certain degree of loosening, i.e. improved solubility of the active substances, is enabled in this way. It is thus necessary to ensure an adequate rebound rate. It should be possible to reproducibly reshape the washing and/or cleaning article without it fracturing.

One preferred embodiment of the inventive washing and/or cleaning article can, lying on a flat supporting surface, along its longest horizontal axis, when the opposite side is held at a fixed location and the opposite side is raised, be bent by ≧3°, preferably ≧5°, more preferably ≧10°, still more preferably ≧15°, more preferably ≧20°. The opening angle between the flat surface and the bent article may also be ≧30°, ≧50°, ≧70°, ≧90°, ≧120° and even ≧150° without the washing and/or cleaning article fracturing.

As mentioned above, preferred inventive washing and/or cleaning articles should be reversibly reshapeable (in the event of irreversible reshaping, no rebound rate could be measured). In further preferred embodiments of the present invention, the reshaping is fully reversible, i.e. preference is given to inventive washing and/or cleaning articles which return to their original shape after cessation of the action of force.

In the context of the present invention, particular preference is given to laundry detergent and cleaning composition articles which disintegrate in water at ≧30° C. in ≦10 min, especially ≦5 min, preferably ≦2 min.

In one embodiment, ≧50% by weight, preferably ≧60% by weight, more preferably ≧70% by weight, still more preferably ≧80% by weight, of the washing and/or cleaning article, based on the total weight thereof, can be dispersed, while 90% of the water-soluble components have dissolved, in water at ≧30° C. within >0-30 min, preferably within 15 min, preferentially within 10 min, more preferably within 5 min, while retaining the shape of the water-insoluble carrier.

It is preferred when at least one layer, preferably all layers, comprise(s) at least one care, washing and/or cleaning substance or consist(s) thereof.

According to the invention, the support(s) may likewise comprise(s) at least one care, washing and/or cleaning substance or consist(s) thereof.

The layer(s) and/or support(s) can be produced simultaneously or successively by means of extrusion, impregnation, casting, roll-coating, knife-coating, spraying, compressing and/or scattering-in.

In a preferred embodiment of the invention, the washing and/or cleaning articles, especially the layer(s) and/or support(s), most preferably the layer(s), are generated by means of extrusion, as described, for example, in the European patent EP-B-0 486 592 or in the International patent applications WO-A-93/02176 and WO-A-94/09 111. In these documents, a solid premixture is mixed under pressure and extruded as a sheetlike structure and the extrudate, after leaving the mold, is cut by means of a cutting apparatus to the predeterminable dimension. The homogeneous and solid premixture comprises a plasticizer and/or lubricant which has the effect that the premixture softens plastically under the pressure or under the input of specific work and becomes extrudable. Preferred plasticizers and/or lubricants are surfactants and/or polymers.

The binder(s) thus has/have to be of such a type that the adhesive properties are retained even at temperatures which are significantly above the melting point or the softening point. On the other hand, it is also essential for the selection of the type and of the amount of the binder(s) used that the binding properties are not lost within the end product after recooling, and the integrity of the end product is thus ensured, but the end product itself does not stick together under customary storage and transport conditions.

In the further course of the description of this invention, reference will only be made for the sake of simplicity to a or the binder. However, it should be made clear that it is always also possible per se to use several different binders and mixtures of different binders.

In a preferred embodiment of the invention, a binder is used that is already fully in molten form at temperatures up to a maximum of 100° C., preferably up to a maximum of 80° C. and in particular at from 40 to 60° C. Depending on the process and process conditions, the binder thus has to be selected, or the process conditions, especially the process temperature, if a certain binder is desired, have to be matched to the binder.

It is advantageous when the layers are applied to a support simultaneously or successively. It is more advantageous when at least one layer, preferably several layers, are disposed between an upper first support and a lower second support.

The layer(s) and/or support(s) may have a high degree of compaction. This is advantageous because skin contact with the inventive washing and/or cleaning article thus results in virtually no, if any, cleaning composition substances being transferred to the skin or hands of the user. The formulation “virtually no” in the context of this invention means that the user, in the event of skin contact with the inventive washing and/or cleaning article, has no unpleasant feel on the hands, and, if at all possible, the impression does not arise that cleaning composition substance such as washing or cleaning substances or the like remain on the skin in the event of contact. It is well known that the soft, flexible washing and/or cleaning articles disclosed by the prior art transfer a sticky, unpleasant cleaning composition film to the hands on contact with the skin. This is distinctly reduced by the inventive cleaning composition article.

Particular preference is given to the outer upper and/or outer lower surface of the washing and/or cleaning article, especially of the support, being free of care, washing and/or cleaning substances, especially free of surfactants.

A further improvement can be achieved by using supports when they each fully cover the upper surface and/or the lower surface of the layered body consisting of at least one layer.

The supports used in the inventive washing and/or cleaning articles may fulfill several functions. One is that the support material may also comprise care, washing and/or cleaning substance or consist thereof. Another is that they are suitable as a cover of the layer which has care, washing and/or cleaning substance and is applied to the first support, and also for protecting the user from skin contact with these substances.

Supports and/or layers having high rebound elasticity allow the release of the washing and/or cleaning substance(s) to be accelerated.

In addition, the layers and/or the support(s) may comprise hollow fibers. In one embodiment, the support may also consist exclusively of hollow fibers.

Further advantageous properties of the inventive washing and/or cleaning article which arise depending on the particular embodiment are listed below:

a release, offset in time, of at least one care, washing and/or cleaning substance physically or chemically bound to and/or into support(s) and/or layer(s) or contained therein, for example soluble builders, color transfer inhibitors, antimicrobial substance(s), perfumes, bleach activators and/or bleach catalysts;

in addition to the modification of the release properties of the bound substance, it is additionally also possible to achieve a saving in certain substances, for example perfumes, since they are not released until a late time during the washing cycle and can thus freely display their action without loss. The content of disintegrants can also be reduced fully or partly, since, for example, the establishment of the rebound elasticity and/or the degree of compaction of the support and/or of the layer(s) allows the solubility of the care, cleaning and/or washing substances disposed in several layers to be increased; the absorption and binding of undesired substances to the support and/or the layer(s), for example dyes, soiling, etc., for example from the wash liquor, so that undesired mutual coloration resulting from different-colored washing and/or graying can be prevented; in addition, the support and/or the layer, depending on the selection of material, may also have antistatic action and subsequently be used in a laundry dryer, i.e. the inventive washing and cleaning article does not have to be initially removed after the wash, but rather can remain directly in the dryer or in the washing machine having dryer function.

Layers, hollow fibers and/or supports which can be used in accordance with the invention may have, as care, washing and/or cleaning substance(s), builders, color transfer inhibitors, antimicrobial substance(s), perfumes, bleaching substance(s) and/or bleach catalysts.

Suitable in principle for use as the support material of the inventive washing and/or cleaning articles are a whole series of fibers such as hollow and/or solid fibers. Especially suitable are textile fibers.

Also suitable in accordance with the invention are support materials based on nonwovens having hollow fibers, preferably having diameter 5-15 their and a staple fiber length of between 6-30 mm and/or a basis weight of 50-150 g/m², for example composed of thermoplastics such as polypropylene (PP), polyethylene (PE), polyamides (PA) and/or polyesters. The elasticity of such supports may be substantially increased either by preceding latex impregnation and/or point hot-adhesive bonding, preferably under pressure.

Textile fibers refer to all fibers which can be processed in a textile manner. For example, suitable fibers may have high length and also adequate strength and bendability in comparison to their cross section.

Textile fibers can be divided by origin or material nature into the following groups:

1. Natural fibers: in the case of these, a distinction is drawn between fibers of vegetable, animal and mineral origin. The vegetable fibers stemming from the fiber plants are further divided into a) seed fibers, for example cotton, kapok, b) bast fibers, for example flax, hemp, jute, kenaf, ramie, rosella, sunn, urena, c) hard fibers, for example alfa grass or esparto grass, fique, henequen, coir, manila, phormium, sisal. Animal fibers are divided into the subgroups a) wool, b) fine animal hairs, for example angora, alpaca, guanaco, camel, rabbit, cashmere, llama, mohair, vicuna, yak, c) coarse animal hairs, for example cattlehair and horsehair, goat hair and d) silks, for example mulberry silk and tussah silk.

2. Chemical fibers: these fibers formally referred to as artificial fibers can be grouped into those of natural and synthetic polymers and of inorganic substances.

a) Modified natural fibers are generally of vegetable origin. These include in particular fibers of regenerated cellulose such as cupro silk, viscous fibers, modal fibers and cellulose acetates such as acetate, triacetate, of alginates such as alginate fibers and polyisoprenes such as rubber. Fibers of regenerated cellulose, occasionally also those of cellulose esters, are often referred to in this context as artificial silk or rayon.

b) Synthetic fibers refer to fully synthetic chemical fibers which are produced from simple organic building blocks (=monomers) by polymerization, polycondensation or polyaddition, i.e. by polyreactions. The synthetic fibers include, for example, the elastomeric fibers such as elastan, elastodiene; fluoro fibers; polyacrylic fibers such as polyacrylonitrile, modacrylics; polyamide fibers such as nylon, aramid; polychloride fibers such as polyvinyl chloride, polyvinylidene chloride; polyester fibers; polyolefin fibers such as polyethylene, polypropylene and polyvinyl alcohol fibers. c) Inorganic chemical fibers may be composed of glass, carbon or metal. To produce fibers, they are brought into a spinnable form and extruded in this state, for example in a solution or as a melt, through narrow-pored orifices, for example dies into a solidifying medium, for example precipitating bath in the case of wet-spinning processes or heated spinning shaft in the case of dry-spinning processes, or shaped to filaments in melt-spinning apparatus, optionally stretched, colored, spun to fibers by various methods and combined to yarns.

It is possible in principle to use water-soluble and/or water-insoluble, either woven or nonwoven materials in the inventive washing and/or cleaning articles, such as nonwoven fabrics, woven fabrics or knits of the abovementioned materials or other suitable materials or mixtures thereof. Materials also useful as supports for the inventive washing and/or cleaning articles include foams, especially open-pore foams, microfibers, nanofibers and/or films; especially suitable are, for example, foams, nonwoven fabrics. The supports may consist of a certain or of material mixtures.

It may equally be advantageous to use water-soluble supports of different materials, so that the care, washing and/or cleaning active substance(s) of the support is/are released with dissolution of the material.

In addition, the inventive washing and/or cleaning articles may have layers comprising care, washing and/or cleaning substance(s), and, in a preferred embodiment, the substance(s) and/or washing substances present may be those that are preferably selected from the group consisting of surfactants, enzymes, builders, bleaches and/or fabric softeners.

These care, washing and/or cleaning substance(s) may be disposed in and/or else between the supports and/or layers, separately from each other or as mixtures of identical or different compositions.

In a particularly preferred embodiment, the article has only one layer between an upper and a lower support, so that care, washing and/or cleaning substance(s) are disposed separately from each other between the supports and in the layer. Preference is given to the layer comprising care, washing and/or cleaning substance(s) or consisting thereof.

With regard to the desired release, offset in time, of the individual care, washing and/or cleaning substance(s), what is especially desirable is distribution of the individual substances on and/or in as many as possible separate layers. Therefore, the inventive washing and/or cleaning article comprises at least two layers, preferably at least three layers, more preferably at least four layers, in which and or on which the same and/or different care, washing and/or cleaning substance(s) is/are disposed. Preference is given to at least one layer comprising care, washing and/or cleaning substance(s) or consisting thereof.

Considering the normally desired profile of release with time during the cleaning process of care, cleaning and/or washing substances, the following rough sequence of release phases can be drawn up:

Phase 1: substantially enzymes;

Phase 2: substantially builders and surfactants;

Phase 3: substantially bleach;

Phase 4: substantially fabric softener and perfume.

The particular release time can be adjusted, for example, by the coating sequence and arrangement of the particular layers and the substance properties of the layers. Preference is given to at least one, preferably all, layer(s) and/or support(s) comprising care, washing and/or cleaning substance(s) or consisting thereof.

Thus, in a particularly preferred embodiment, the inventive washing and/or cleaning article consists of a support to which the care, washing and/or cleaning substance(s) to be released as late as possible, for example perfume or fabric softener, are chemically or physically bound. Disposed on this support as the first care, washing and/or cleaning substance(s) is a layer having bleach and optionally substances having a similar action. The next layer has builders and optionally substances having similar action. On this layer is subsequently disposed a layer having enzymes and similar substances and thereon is disposed a layer having a surfactant mixture which is to be released very rapidly. This layer is covered, for example, by a nonwoven support which may optionally be water-soluble, so that the substance release from this side of the washing and/or cleaning article may be particularly rapid.

The supports used, for example for covering a layer, may also be water-soluble polymers which are sprayed on or jetted on as a liquid and, after conditioning, result in a thin film.

However, it will be appreciated that fewer or more layers may also be present in the inventive washing and/or cleaning article and/or another distribution of the care, washing and/or cleaning substance(s) in the layers is immediately possible.

With regard to the size and shape of the inventive washing and/or cleaning article, a large number of different shapes and sizes is conceivable in principle. These are generally determined merely by, on the one hand, an adequately large surface area to include the care, washing and/or cleaning substance(s) to be absorbed and/or adsorbed by the support and for the application of the layers comprising care, washing and/or cleaning substance(s) and/or consisting thereof, and, on the other hand, by a size which is still pleasant to handle and is acceptable for the user.

In addition, the washing and/or cleaning articles may be stacked as individual portions in a dispenser or be designed in the shape of foldable sheets. Sheets which can be torn off from rolls may also be suitable when the washing and/or cleaning article is designed with appropriate bendability. Depending on which application form the inventive washing and/or cleaning article is in, embossing or stamping of the cleaning article is viable in order to impart stability to it. Especially in the case of the variants that can be torn off, intended break edges should be prestamped.

In addition, the supports may also be printed, for example with use instructions, or colored, which is especially conducive to consumer information, esthetics and the individualization of the article.

In view of the properties of the inventive washing and/or cleaning articles illustrated, a distinct improvement in the laundry detergent and cleaning composition formulations known hitherto from the prior art could thus be achieved. In addition to the properties already explained such as:

simple handling and portioning,

successful avoidance of contact with the user and

the release, offset in time, of the care, washing and/or cleaning substance(s) which has the consequence of a dramatic saving of substance(s) and/or washing substances, and also the particular properties of the support, preferably having several functions,also results in particular in the following advantages resulting from the properties of the inventive washing and/or cleaning article, depending on the particular embodiment:

no loss of laundry detergent by clumping or deposition of laundry detergent in the washing machine or in the laundry items,

homogeneity of the individual components by layer arrangement,

freedom from dusting, and

in some cases, rebound elasticity may prevent, for example, occurrences including deposition in the gaps of the washing machine or in bundles of laundry.

In one embodiment, the washing and/or cleaning article, on cessation of the action of a reshaping force, has a rebound rate v a rebound rate v of ≧0.001 mm/min and ≦10 000 mm/min, preferably ≧10 mm/min, preferentially ≧100 mm/min, more preferably ≧1000 mm/min.

It is preferred that at least one support and/or at least one layer is based on extruded care, washing and/or cleaning substance.

It is advantageous when care, washing and/or cleaning substance is disposed between the outer surface of at least one support and the outer surface of a layer facing this surface.

It is further advantageous when care, washing and/or cleaning substance is disposed at least between the outer surface of a first layer and the outer surface of a second layer facing this surface.

The care, washing and/or cleaning substance(s) disposed between facing outer surfaces may be held in a securable, adhesive and/or adsorptive manner; the substance(s) is/are preferably embedded.

It is particularly advantageous that at least one layer and/or at least one support, preferably at least one extruded layer and/or at least one extruded support, comprise(s) care, washing and/or cleaning substance(s) in the form of solid, liquid, gel-like and/or pasty bodies.

These bodies include particles, agglomerates, powders, granules and/or drops.

At least one layer and/or support, preferably each layer and/or each support, may have a solubility improver and/or a plasticizing assistant.

The washing and/or cleaning article may have at least one care, washing and/or cleaning substance selected from the group consisting of surfactants, disintegration assistants, enzymes, builders, cobuilders, bleaches, bleach activators, bleach stabilizers, bleach catalysts, polymers, fabric softeners, rinse aids, alkalizing agents, acidifying agents, antiredeposition agents, color transfer inhibitors, silver protectants, graying inhibitors, soil-repellent substances, optical brighteners, antimicrobial substances, fragrances, perfumes, dyes, UV protection substances and/or assistants and additives.

The surfactants are selected from the group consisting of anionic surfactants, nonionic surfactants, cationic surfactants, amphoteric surfactants, amino acids, alkyl-substituted amino acids, acylated amino acids and/or gemini surfactants.

Assistants and/or additives are selected from the group consisting of anticrease agents, foam inhibitors, antioxidants, antistats, substances for improving the rewettability, UV absorbents, complexing agents, agents for adjusting the pH and/or enzyme stabilizers.

At least one support and/or one layer, preferably the washing and/or cleaning article, may consist of water-soluble material.

It is preferred when ≧50% by weight, preferably ≧60% by weight, more preferably ≧70% by weight, still more preferably ≧80% by weight, particularly preferably ≧90% by weight and most preferably ≧99% by weight, of the active substances in the washing and/or cleaning article, based on all of the active substances in the washing and/or cleaning article, dissolve in water at ≧30° C. within ≧0-30 min, preferably within 15 min, preferentially within 10 min, more preferably within 5 min and most preferably within 1-3 min.

Unless stated otherwise in the description, data by weight are based on the total weight of the washing and/or cleaning article. Moreover, the particular data by weight of the substances are to be selected in such a way that the total weight of the washing and/or cleaning article does not exceed 100% by weight.

The support may comprise woven and/or nonwoven materials, preferably nonwoven fabrics, woven fabrics, films and/or knits.

The materials of the support are selected from the group consisting of foams, especially open-pore foams, synthetic and/or natural fibers, preferably microfibers, nanofibers, hollow fibers and/or solid fibers.

The strength of the polyacrylate foam or nonwoven fabric may be increased by crosslinking with suitable thermoplastics, especially polyethylene (PE). This may achieve retention of the three-dimensional network of the support swollen with water or wash liquor, for example of a polyacrylate foam or nonwoven fabric. This is advantageous because it allows, for example, removal of the support after the washing operation.

The particular layers of the washing and/or cleaning article may have the same or different contents by weight of care, washing and/or cleaning substance.

Layers and/or supports comprising one or more care, washing and/or cleaning substances may each have one or more identical or different care, washing and/or cleaning substance(s).

The washing and/or cleaning article of any of the preceding claims may have at least one enzyme-containing layer free of bleach and/or at least one bleach-containing layer free of enzyme.

The inventive washing and/or cleaning article may have at least one dye- and/or fragrance-containing layer free of bleach and/or at least one bleach-containing layer free of dye and/or fragrance.

It is advantageous when at least one layer and/or at least one support of the washing and/or cleaning article comprises care, washing and/or cleaning substance in granule form, preferably enzyme granule.

It is preferred when care, washing and/or cleaning substance in granule form, preferably enzyme granule, is disposed, preferably embedded, between at least one outer surface of a first layer and the outer surface of a support and/or of a second layer facing said surface. It is particularly preferred when the granule is coated granule.

The thickness of the washing and/or cleaning article amounts to from between 0.5 mm and 2 cm, preferably from between 1 mm and 1.5 cm, preferentially from between 2 mm and 1.2 cm, more preferentially from between 4 mm and 1.2 cm and still more preferentially from between 6 mm and 1 cm.

The thickness of the layers depends decisively upon the number of layers. The total height or thickness of the washing and/or cleaning article is preferably ≦1 cm.

Preferably, the layer height or layer thickness of a layer amounts to from between ≧0.1 mm and ≦1.2 cm, preferably from between ≧0.2 mm and ≦1 cm, preferentially from between ≧0.4 mm and ≦0.8 cm, further preferably from between ≧0.6 mm and ≦0.6 cm, more preferably from between ≧0.6 mm and ≦0.4 cm, still more preferably from between ≧0.8 mm and ≦0.3 cm and most preferably from between ≧1 mm and ≦2 mm.

In a washing and/or cleaning article having three layers, each layer preferably has a layer thickness of ≦2 mm.

The washing and/or cleaning article preferably has a weight of between 10 g and 140 g, preferably of between 25 g and 100 g, more preferably of between 35 g and 90 g and still more preferably of between 40 g and 85 g.

The outer upper support surface and/or the outer lower support surface of the washing and/or cleaning article which is/are not in contact with an outer surface of a layer may not have any care, washing and/or cleaning substance.

At least one layer and/or at least one support has at least two, preferably at least three, preferentially at least four, care, washing and/or cleaning substances.

At least two, preferably at least three, preferentially at least four, care, washing and/or cleaning substances can be applied between two layers, between one layer and one support and/or between one support and one layer.

A preferred embodiment of the inventive washing and/or cleaning article has a lower support and an upper support composed of textile material, between which at least one layer, preferably from 2 to 10 layers, based on at least one, preferably from 2 to 10, care, washing and/or cleaning substance(s), is/are disposed, and the outer upper surface of the support and the outer lower surface of the support are optionally free of care, washing and/or cleaning substance(s).

In one embodiment, the present invention comprises a dimensionally stable washing and/or cleaning article in solid form, characterized in that the washing and/or cleaning article is reversibly bendable; comprises at least one layer which has at least one care, washing and/or cleaning substance and at least one binder, the layer(s) being disposed on a support or in a sandwich-like manner between two supports; and at least one support may optionally be highly elastic. In one embodiment, the washing and/or cleaning article has a modulus of elasticity at 20° C. of ≧0.01 MPa and ≦1000 MPa, preferably ≧0.1 MPa, preferentially ≧100 MPa. In one embodiment, the washing and/or cleaning article, on cessation of the action of a reshaping force, a rebound rate v of ≧0.001 mm/min and ≦10 000 mm/min, preferably ≧10 mm/min, preferentially ≧100 mm/min, more preferably ≧1000 mm/min. In one embodiment, washing and/or cleaning article includes at least one support and/or at least one layer is based on extruded care, washing and/or cleaning substance. In one embodiment, the care, washing and/or cleaning substance is disposed between the outer surface of at least one support and the outer surface of a layer facing said surface. In one embodiment, the care, washing and/or cleaning substance is disposed at least between the outer surface of a first layer and the outer surface of a second layer facing said surface. In one embodiment, the care, washing and/or cleaning substance(s) disposed between facing outer surfaces is held in a securable, adhesive and/or adsorptive manner, preferably embedded. In one embodiment, the bodies are particles, agglomerates, powders, fibers, granules and/or drops. In one embodiment, at least one layer and/or support, preferably each layer and/or support, has a solubility improver and/or a plasticizing assistant. In one embodiment, at least one care, washing and/or cleaning substance is selected from the group consisting of surfactants, disintegration assistants, enzymes, builders, cobuilders, bleaches, bleach activators, bleach stabilizers, bleach catalysts, polymers, fabric softeners, rinse aids, alkalizing agents, acidifying agents, antiredeposition agents, color transfer inhibitors, silver protectants, graying inhibitors, soil-repellent substances, optical brighteners, antimicrobial substances, fragrances, perfumes, dyes, UV protection substances and/or assistants and additives.

In one embodiment, the surfactants are selected from the group consisting of anionic surfactants, nonionic surfactants, cationic surfactants, amphoteric surfactants, amino acids, alkyl-substituted amino acids, acylated amino acids and/or gemini surfactants. In one embodiment, the assistants and/or additives are selected from the group consisting of anticrease agents, foam inhibitors, antioxidants, antistats, substances for improving the rewettability, UV absorbents, complexing agents, agents for adjusting the pH and/or enzyme stabilizers. In one embodiment, at least one support and/or one layer, preferably the washing and/or cleaning article, consists of water-soluble material. In one embodiment, the laundry detergent and cleaning composition article disintegrates in water at ≧30° C. in ≦10 min, especially in ≦5 min, preferably ≦2 min. In one embodiment, ≧50% by weight, preferably ≧60% by weight, more preferably ≧70% by weight, still more preferably ≧80% by weight, of the washing and/or cleaning article, based on the total weight thereof, is dispersed, and 90% of the water-soluble components has dissolved, in water at ≧30° C. within ≧0-30 min, preferably within 15 min, preferentially within 10 min, more preferably within 5 min, while retaining the shape of the water-insoluble carrier.

In one embodiment, the support comprises woven and/or nonwoven materials, preferably nonwoven fabrics, woven fabrics, films and/or knits. In one embodiment, the materials of the support are selected from the group consisting of foams, especially open-pore foams, synthetic and/or natural fibers, preferably microfibers, nanofibers, hollow and/or solid fibers. In one embodiment, layers have the same and/or different contents by weight of care, washing and/or cleaning substance, based on the total weight of the particular layer. In one embodiment, the layers and/or supports comprising one or more care, washing and/or cleaning substances each have one or more identical or different care, washing and/or cleaning substance(s). In one embodiment, at least one enzyme-containing layer is free of bleach and/or at least one bleach-containing layer is free of enzyme. In one embodiment, at least one dye- and/or fragrance-containing layer is free of bleach and/or at least one bleach-containing layer is free of dye and/or fragrance. In one embodiment, at least one layer and/or at least one support comprises care, washing and/or cleaning substance in granule form, preferably enzyme granule. In one embodiment, the care, washing and/or cleaning substance in granule form, preferably enzyme granule, is disposed, preferably embedded, between at least one outer surface of a first layer and the outer surface of a support and/or of a second layer facing said surface. In one embodiment, the granule is coated granule.

In one embodiment, the thickness of the washing and/or cleaning article amounts to from between 0.5 mm and 2 cm, preferably from between 1 mm and 1.5 cm, preferentially from between 2 mm and 1.2 cm, more preferentially from between 4 mm and 1.2 cm and still more preferentially from between 6 mm and 1 cm. In one embodiment, the washing and/or cleaning article has a weight of between 10 g and 140 g, preferably of between 25 g and 100 g, more preferably of between 35 g and 90 g and still more preferably of between 40 g and 85 g. In one embodiment, at least one layer and/or at least one support has at least two, preferably at least three, preferentially at least four, care, washing and/or cleaning substances. In one embodiment, at least two, preferably at least three, preferentially at least four, care, washing and/or cleaning substances are applied between two layers, between one layer and one support and/or between one support and one layer.

In one embodiment, the washing and/or cleaning article has a lower support and an upper support composed of textile material, between which at least one layer, preferably from 2 to 10 layers, based on at least one, preferably from 2 to 10, care, washing and/or cleaning substance(s), is/are disposed. In one embodiment, the the washing and/or cleaning article comprises a lower, preferably water-soluble support which optionally has care, washing and/or cleaning substance(s), preferably selected from the group consisting of builders, color transfer inhibitors, antimicrobial substance(s), perfumes, bleaching substance(s) and/or bleach catalysts; a first, preferably extruded layer disposed thereon, said first layer comprising care, washing and/or cleaning substance(s), preferably bleach; a further second, preferably scattered-in or scattered-on, layer disposed on the first layer, said second layer having care, washing and/or cleaning substance(s), preferably builders; a further third, preferably knife-coated, layer disposed on the second layer, said third layer having care, washing and/or cleaning substance(s), preferably enzymes; a further fourth, preferably poured layer disposed on the third layer, said fourth layer having care, washing and/or cleaning substance(s), preferably surfactant; and a preferably water-soluble support disposed on the fourth layer, said support optionally having care, washing and/or cleaning substance(s), preferably selected from the group consisting of builders and color transfer inhibitors.

In one embodiment, the washing and/or cleaning article comprises: a lower, preferably water-soluble support which optionally has care, washing and/or cleaning substance(s), preferably selected from the group consisting of builders, color transfer inhibitors, antimicrobial substance(s), perfumes, bleaching substance(s) and/or bleach catalysts; a first, preferably extruded or poured layer disposed thereon, said first layer having care, washing and/or cleaning substance(s), preferably builders and surfactants; a further second, preferably extruded, layer disposed on the first layer, said second layer having care, washing and/or cleaning substance(s), preferably bleaches and/or bleach activators; a further third, preferably extruded or poured, layer disposed on the second layer, said third layer having care, washing and/or cleaning substance(s), preferably builders and surfactants; a further fourth, preferably scattered-in or scattered-on, layer disposed on the third layer, said fourth layer having care, washing and/or cleaning substance(s), preferably enzymes; and a preferably water-soluble support disposed on the fourth layer, said support optionally having care, washing and/or cleaning substance(s), preferably selected from the group consisting of builders, color transfer inhibitors, antimicrobial substance(s), perfumes, bleaching substance(s) and/or bleach catalysts.

In one embodiment, the washing and/or cleaning article comprises scattered-in or scattered-on pulverulent and/or granular care, washing and/or cleaning substance(s) between extruded and/or poured layer(s). In one embodiment, the washing and/or cleaning article, especially the layer(s) and/or support have polyacrylate, preferably polyacrylate salt builder, as an additive, preferably in the form of solids, in particular powders, fibers and/or granules, whose volume increases under wash conditions by ≧100 times, preferably ≧500 times and more preferably ≧1000 times.

In one embodiment, a process is disclosed for producing the washing and/or cleaning article of any of the preceding claims, in which a layer composed of at least one care, washing and/or cleaning substance(s) is applied to the upper surface of a support. In one embodiment, at least one layer, preferably all layers, comprising at least one care, washing and/or cleaning substance(s), is obtained by unrolling sheetlike structures, extruding, knifecoating, roll application, scattering-in, casting, spraying, pressing and/or scattering-in. In one embodiment, a process comprises the following steps:

a) unrolling sheetlike structures;

b) extruding, knifecoating, roll application, scattering-in, casting and/or spraying;

c) cutting

d) stamping

e) conditioning

f) compressing

g) packaging,

of which individual or multiple steps may be omitted or repeated.

In one embodiment, the layers are not constructed by impregnation, but rather substantially by dry application, and the individual layers are compressed by smooth and/or surface-structured rolls, where necessary, partly mixed. In one embodiment, water sparingly soluble care, washing and/or cleaning substances, for example surfactants, are applied in foamed form, and/or builders, for example disilicates, are applied in anhydrous form, i.e. in solid particulate form, and/or bleaches, for example percarbonate and perborate, are applied as solids. In one embodiment, mutually influencing layers such as a percarbonate layer, surfactant layer and/or enzyme layer are protected from one other by film coatings, preferably applied by means of spray processes.

In one embodiment, the washing and/or cleaning article is used for cleaning hard and/or soft surfaces, preferably textiles, more preferably textiles in washing machines.

In a further preferred embodiment of the inventive washing and/or cleaning article, the latter has: a lower, preferably water-soluble support which optionally has care, washing and/or cleaning substance(s), preferably selected from the group consisting of builders, color transfer inhibitors, antimicrobial substance(s), perfumes, bleaching substance(s) and/or bleach catalysts; a first, preferably extruded layer disposed thereon, said first layer comprising care, washing and/or cleaning substance(s), preferably bleach; a further second, preferably scattered-in or scattered-on, layer disposed on the first layer, said second layer having care, washing and/or cleaning substance(s), preferably builders; a further third, preferably knife-coated, layer disposed on the second layer, said third layer having care, washing and/or cleaning substance(s), preferably enzymes; a further fourth, preferably poured layer disposed on the third layer, said fourth layer having care, washing and/or cleaning substance(s), preferably surfactant; and a preferably water-soluble support disposed on the fourth layer, said support optionally having care, washing and/or cleaning substance(s), preferably selected from the group consisting of builders, color transfer inhibitors, antimicrobial substances(s), perfumes, bleaching substance(s) and/or bleach catalysts.

In a second preferred embodiment of the inventive washing and/or cleaning article, the latter has: a lower, preferably water-soluble support which optionally has care, washing and/or cleaning substance(s), preferably selected from the group consisting of builders, color transfer inhibitors, antimicrobial substance(s), perfumes, bleaching substance(s) and/or bleach catalysts; a first, preferably extruded or poured layer disposed thereon, said first layer having care, washing and/or cleaning substance(s), preferably builders and surfactants; a further second, preferably extruded, layer disposed on the first layer, said second layer having care, washing and/or cleaning substance(s), preferably bleaches and/or bleach activators; a further third, preferably extruded or poured, layer disposed on the second layer, said third layer having care, washing and/or cleaning substance(s), preferably builders and surfactants; a further fourth, preferably scattered-in or scattered-on, layer disposed on the third layer, said fourth layer having care, washing and/or cleaning substance(s), preferably enzymes; and a preferably water-soluble support disposed on the fourth layer, said support optionally having care, washing and/or cleaning substance(s), preferably selected from the group consisting of builders, color transfer inhibitors, antimicrobial substance(s), perfumes, bleaching substance(s) and/or bleach catalysts.

In a further embodiments, pulverulent and/or granular care, washing and/or cleaning substance(s) may be scattered in or scattered on between extruded and/or poured layers.

At least one support and/or at least one layer may comprise at least one water-soluble thermoplastic or consist of thermoplastic. The thermoplastic is preferably selected from the group consisting of polyvinyl alcohol (PVA), acetalized polyvinyl alcohol, polyvinylpyrrolidone, polyethylene oxide, gelatin, cellulose, starch and derivatives of the aforementioned substances, polyvinyl alcohol (PVA), acetalized polyvinyl alcohol and/or mixtures of the aforementioned polymers, of which particular preference is given to polyvinyl alcohol.

The above-described polyvinyl alcohols are commercially available, for example under the trade mark MOWIOL® (Clariant). Particularly suitable polyvinyl alcohols in the context of the present invention are, for example, MOWIOL® 3-83, MOWIOL® 4-88, MOWIOL® 5-88, MOWIOL® 8-88 and CLARIANT L648.

Further particularly suitable polyvinyl alcohols can be taken from the following TABLE 1:

TABLE 1

| | Degree of | Molar mass | Melting point |
|---|---|---|---|
| Designation | hydrolysis [%] | [kDa] | [° C.] |
| AIRVOL ® 205 | 88 | 15-27 | 230 |
| VINEX ® 2019 | 88 | 15-27 | 170 |
| VINEX ® 2144 | 88 | 44-65 | 205 |
| VINEX ® 1025 | 99 | 15-27 | 170 |
| VINEX ® 2025 | 88 | 25-45 | 192 |
| GOHSEFIMER ® 5407 | 30-28 | 23 600 | 100 |
| GOHSEFIMER ® LL02 | 41-51 | 17 700 | 100 |

Further suitable polyvinyl alcohols are ELVANOL® 51-05, 52-22, 50-42, 85-82, 75-15, T-25, T-66, 90-50 (trade mark of Du Pont), ALCOTEX® 72.5, 78, B72, F80/40, F88/4, F88/26, F88/40, F88/47 (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K.K.).

The water-soluble thermoplastic useful when forming the support may additionally have polymers selected from the group consisting of acrylic acid-containing polymers, polyacrylamides, oxazoline polymers, polystyrene sulfonates, polyurethanes, polyesters, polyethers and/or mixtures of the above polymers.

It is preferred when the water-soluble thermoplastic used includes a polyvinyl alcohol whose degree of hydrolysis amounts to from 70 to 100 mol %, preferably from 80 to 90 mol %, more preferably from 81 to 89 mol % and in particular from 82 to 88 mol %.

It is more preferred that the water-soluble thermoplastic used comprises a polyvinyl alcohol whose molecular weight is in the range from 10 000 to 100 000 gmol⁻¹, preferably from 11 000 to 90 000 gmol⁻¹, more preferably from 12 000 to 80 000 gmol⁻¹ and in particular from 13 000 to 70 000 gmol⁻¹.

In a further embodiment, at least one support and/or the layer(s) includes the thermoplastics mentioned in amounts of at least 50% by weight, preferably of at least 70% by weight, more preferably of at least 80% by weight and in particular of at least 90% by weight, based in each case on the weight of the particular support or the particular layer.

The constituents and components used in the inventive cleaning compositions are now to be illustrated in detail hereinbelow. As already explained, the substances listed are preferably distributed in the supports and/or in the layers disposed between the supports. However, they may also be present in and/or on the layer(s) and/or in and/or on the supports. Preference is given to at least one layer and/or support comprising care, washing and/or cleaning substance(s) or consisting thereof.

Surfactants

In the inventive washing and/or cleaning articles, anionic, nonionic, cationic and/or amphoteric surfactants may be used. The total surfactant content based on the total content of substance(s) and/or washing substances of the inventive cleaning article is preferably from 1 to 50% by weight, more preferably from 5 to 40% by weight, particularly preferably from 10 to 30% by weight and in particular from 15 to 25% by weight.

Anionic Surfactants

For example, sulfonate-type and sulfate-type anionic surfactants may be used. Useful sulfonate-type surfactants are preferably C₉₋₁₃-alkylbenzenesulfonates, olefinsulfonates, i.e. mixtures of alkene- and hydroxyalkanesulfonates, and also disulfonates, as obtained, for example, from C₁₂₋₁₈-monoolefins having terminal or internal double bonds by sulfonation with gaseous sulfur trioxide and subsequent alkaline or acidic hydrolysis of the sulfonation products. Suitable are alkylsulfonates which are obtained from C₁₂₋₁₈-alkanes, for example by sulfochlorination or sulfoxidation with subsequent hydrolysis and neutralization respectively. Alkylsulfonates (INCI Sulfonic Acids) typically have an aliphatic, straight-chain or mono- or polybranched, acyclic or cyclic, saturated or mono- or polyunsaturated, preferably branched, acyclic, saturated alkyl radical having from 6 to 22, preferably from 9 to 20, in particular from 11 to 18 and more preferably from 13 to 17, carbon atoms. Suitable alkylsulfonates are accordingly the saturated alkanesulfonates, the unsaturated olefinsulfonates and the ether sulfonates (deriving in a formal sense from the alkoxylated alcohols on which the alkyl ether sulfates are also based) in which terminal ether sulfonates (n-ether sulfonates) having sulfonate function bonded to the polyether chain and internal ether sulfonates (i-ether sulfonates) with sulfonate function bonded to the alkyl radical. Preference is given in accordance with the invention to the alkylsulfonates, in particular alkylsulfonates having a branched, preferably secondary, alkyl radical, preferably the secondary alkanesulfonate sec. sodium C₁₃₋₁₇-alkanesulfonate (INCI Sodium C14-17 Alkyl Sec Sulfonate).

Arylsulfonates used with preference are alkylbenzenesulfonates, in which the alkyl radicals are branched and unbranched chains having C1-C20, preferably C2-C18, more preferably C6-C16 and most preferably C8-C12. Particularly preferred examples in this context are LAS and/or cumenesulfonate.

Equally suitable are also the esters of α-sulfo fatty acids (ester sulfonates), for example the α-sulfonated methyl esters of hydrogenated coconut, palm kernel or tallow fatty acids.

Suitable further anionic surfactants are in particular lignosulfonates, fatty acid cyanamides, anionic sulfosuccinic acid surfactants, fatty acid isethionates, acylaminoalkanesulfonates (fatty acid taurides), fatty acid sarcosinates, ether carboxylic acids and alkyl (ether) phosphates.

Also suitable are sulfonation products of unsaturated fatty acids, for example oleic acid. Especially preferred are α-sulfo fatty acid alkyl esters which have an alkyl chain having not more than 4 carbon atoms in the ester group, for example methyl esters, ethyl esters, propyl esters and butyl esters. With particular advantage, the methyl esters of α-sulfo fatty acids (MES), but also their hydrolyzed disalts are used.

Further suitable anionic surfactants are sulfated fatty acid glycerol esters. Fatty acid glycerol esters refer to the mono-, di- and triesters and also mixtures thereof, as obtained in the preparation by esterification of a monoglycerol with from 1 to 3 mol of fatty acid or in the reaction of triglycerides with from 0.3 to 2 mol of glycerol. Preferred sulfated fatty acid glycerol esters are the sulfonation products of saturated fatty acids having from 6 to 22 carbon atoms, for example of caproic acid, caprylic acid, capric acid, myristic acid, lauric acid, palmitic acid, stearic acid or behenic acid.

In the present invention, alkyl sulfates, for example fatty alcohol sulfates, may also be used. Suitable alkyl sulfates are sulfates of saturated and unsaturated fatty alcohols of C₆-C₂₂, preferably C₁₀-C₁₈ and more preferably of C₁₁-C₁₆. Particularly suitable alkyl sulfates are those having native C12-14-16 step and/or petrochemical C12-C13, C14-C15 step in the range from 0 to 15%, preferably 0-10%, more preferably 0-8%. Preferred alk(en)yl sulfates are the alkali metal and in particular the sodium salts of sulfuric monoesters of C₁₂-C₁₈ fatty alcohols, for example of coconut fatty alcohol, tallow fatty alcohol, lauryl, myristyl, cetyl or stearyl alcohol or of the C₁₀-C₂₀ oxo alcohols and those monoesters of secondary alcohols of these chain lengths. Also preferred are alk(en)yl sulfates of the chain length mentioned which contain a synthetic, straight-chain alkyl radical prepared on a petrochemical basis, said alk(en)yl sulfates having similar degradation behavior to the equivalent compounds based on fatty chemical raw materials. From the detergent point of view, preference is given to the C₁₂-C₁₆-alkyl sulfates and C₁₂-C₁₅-alkyl sulfates and also C₁₄-C₁₅-alkyl sulfates. 2,3-Alkyl sulfates which are prepared, for example, in accordance with the U.S. Pat. No. 3,234,258 or U.S. Pat. No. 5,075,041, and are obtainable as trade products of the Shell Oil Company under the name DAN® are also suitable anionic surfactants.

The alkyl ether sulfates (fatty alcohol ether sulfates, INCI Alkyl Ether Sulfates) which are also suitable are products of sulfation reactions on alkoxylated alcohols. Alkoxylated alcohols are generally understood by those skilled in the art as meaning the reaction products of alkylene oxide, preferably ethylene oxide, with alcohols, preferably in the context of the present invention with relatively long-chain alcohols, i.e. with aliphatic, straight-chain or mono- or polybranched, acyclic or cyclic, saturated or mono- or polyunsaturated, preferably straight-chain, acyclic, saturated, alcohols having from 6 to 22, preferably from 8 to 18, in particular from 10 to 16 and more preferably from 12 to 14, carbon atoms. In general, n mol of ethylene oxide and one mol of alcohol, depending on the reaction conditions, form a complex mixture of addition products of different degrees of ethoxylation (n=from 1 to 30, preferably from 0.3 to 20, in particular from 0.3 to 10, more preferably from 0.3 to 5). A further embodiment of the alkoxylation consists in the use of mixtures of alkylene oxides, preferably of a mixture of ethylene oxide and propylene oxide. Very particular preference is given in the context of the present invention to fatty alcohols having low degrees of ethoxylation of from 0.3 to 4 ethylene oxide units (EO), in particular from 0.3 to 2 EO, for example 0.5 EO, 1.0 EO, 1.3 EO and/or 2.0 EO, such as sodium (C₁₂₋₁₄ fatty alcohol+0.5 EO) sulfate, sodium (C₁₂₋₁₄ fatty alcohol+1.3 EO) sulfate, sodium (C₁₂₋₁₄ fatty alcohol+2.0 EO) sulfate and/or magnesium (C₁₁₋₁₄ fatty alcohol+1.0 EO) sulfate.

Also suitable are the sulfuric monoesters of straight-chain or branched C₇₋₂₁ alcohols ethoxylated with from 1 to 6 mol of ethylene oxide, such as 2-methyl-branched C₉₋₁₁-alcohols with on average 3.5 mol of ethylene oxide (EO) or C₁₂₋₁₈ fatty alcohols with from 1 to 4 EO.

Preferred further anionic surfactants are the anionic sulfosuccinic acid surfactants, sulfosuccinates, sulfosuccinamates and sulfosuccinamides, in particular sulfosuccinates and sulfosuccinamates, extremely preferably sulfosuccinates. The sulfosuccinates are the salts of the mono- and diesters of sulfosuccinic acid HOOCCH(SO₃H)CH₂COOH, while the sulfosuccinamates refer to the salts of monoamides of sulfosuccinic acid and the sulfosuccinamides to the salts of diamides of sulfosuccinic acid. A comprehensive description of these known anionic surfactants is provided by A. Domsch and B. Irrgang in Anionic surfactants: organic chemistry (edited by H. W. Stache; Surfactant science series; volume 56; ISBN 0-8247-9394-3; Marcel Dekker, Inc., New York 1996, p. 501-549).

The salts are preferably alkali metal salts, ammonium salts and also mono-, di- and trialkanolammonium salts, for example mono-, di- and triethanolammonium salts, in particular lithium, sodium, potassium or ammonium salts, more preferably sodium or ammonium salts, extremely preferably sodium salts.

In the sulfosuccinates, one or both carboxyl groups of sulfosuccinic acid has/have preferably been esterified with one or two identical or different, unbranched or branched, saturated or unsaturated, acyclic or cyclic, optionally alkoxylated alcohols having from 4 to 22, preferably from 6 to 20, in particular from 8 to 18, more preferably from 10 to 16, extremely preferably from 12 to 14, carbon atoms. Particular preference is given to the esters of unbranched and/or saturated and/or acyclic and/or alkoxylated alcohols, in particular unbranched, saturated fatty alcohols and/or unbranched, saturated fatty alcohols alkoxylated with ethylene oxide and/or propylene oxide, preferably ethylene oxide, and having a degree of alkoxylation of from 1 to 20, preferably from 1 to 15, in particular from 1 to 10, more preferably from 1 to 6, extremely preferably from 1 to 4. In the context of the present invention, the monoesters are preferred over the diesters. A particularly preferred sulfosuccinate is sulfosuccinic acid lauryl polyglycol ester disodium salt (lauryl-EO sulfosuccinate, disodium salt; INCI Disodium Laureth Sulfosuccinate), which is commercially available, for example, as Tego® Sulfosuccinat F 30 (Goldschmidt) having a sulfosuccinate content of 30% by weight.

In the sulfosuccinamates or sulfosuccinamides, one or both carboxyl groups of sulfosuccinic acid preferably form(s) a carboxamide with a primary or secondary amine which bears one or two identical or different, unbranched or branched, saturated or unsaturated, acyclic or cyclic, optionally alkoxylated alkyl radicals having from 4 to 22, preferably from 6 to 20, in particular from 8 to 18, more preferably from 10 to 16, extremely preferably from 12 to 14, carbon atoms. Particular preference is given to unbranched and/or saturated and/or acyclic alkyl radicals, in particular unbranched, saturated fatty alkyl radicals.

Also suitable are, for example, the following sulfosuccinates and sulfosuccinamates designated according to INCI, which are described in detail in International Cosmetic Ingredient Dictionary and Handbook: Ammonium Dinonyl Sulfosuccinate, Ammonium Lauryl Sulfosuccinate, Diammonium Dimethicone Copolyol Sulfosuccinate, Diammonium Lauramido-MEA Sulfosuccinate, Diammonium Lauryl Sulfosuccinate, Diammonium Oleamido PEG-2 Sulfosuccinate, Diamyl Sodium Sulfosuccinate, Dicapryl Sodium Sulfosuccinate, Dicyclohexyl Sodium Sulfosuccinate, Diheptyl Sodium Sulfosuccinate, Dihexyl Sodium Sulfosuccinate, Diisobutyl Sodium Sulfosuccinate, Dioctyl Sodium Sulfosuccinate, Disodium Cetearyl Sulfosuccinate, Disodium Cocamido MEA-Sulfosuccinate, Disodium Cocamido MIPA-Sulfosuccinate, Disodium Cocamido PEG-3 Sulfosuccinate, Disodium Coco-Glucoside Sulfosuccinate, Disodium Cocoyl Butyl Gluceth-10 Sulfosuccinate, Disodium C12-15 Pareth Sulfosuccinate, Disodium Deceth-5 Sulfosuccinate, Disodium Deceth-6 Sulfosuccinate, Disodium Dihydroxyethyl Sulfosuccinylundecylenate, Disodium Dimethicone Copolyol Sulfosuccinate, Disodium Hydrogenated Cottonseed Glyceride Sulfosuccinate, Disodium Isodecyl Sulfosuccinate, Disodium Isostearamido MEA-Sulfosuccinate, Disodium Isostearamido MIPA-Sulfosuccinate, Disodium Isostearyl Sulfosuccinate, Disodium Laneth-5 Sulfosuccinate, Disodium Lauramido MEA-Sulfosuccinate, Disodium Lauramido PEG-2 Sulfosuccinate, Disodium Lauramido PEG-5 Sulfosuccinate, Disodium Laureth-6 Sulfosuccinate, Disodium Laureth-9 Sulfosuccinate, Disodium Laureth-12 Sulfosuccinate, Disodium Lauryl Sulfosuccinate, Disodium Myristamido MEA-Sulfosuccinate, Disodium Nonoxynol- 10 Sulfosuccinate, Disodium Oleamido MEA-Sulfosuccinate, Disodium Oleamido MIPA-Sulfosuccinate, Disodium Oleamido PEG-2 Sulfosuccinate, Disodium Oleth-3 Sulfosuccinate, Disodium Oleyl Sulfosuccinate, Disodium Palmitamido PEG-2 Sulfosuccinate, Disodium Palmitoleamido PEG-2 Sulfosuccinate, Disodium PEG-4 Cocamido MIPA-Sulfosuccinate, Disodium PEG-5 Laurylcitrate Sulfosuccinate, Disodium PEG-8 Palm Glycerides Sulfosuccinate, Disodium Ricinoleamido MEA-Sulfosuccinate, Disodium Sitostereth-14 Sulfosuccinate, Disodium Stearamido MEA-Sulfosuccinate, Disodium Stearyl Sulfosuccinamate, Disodium Stearyl Sulfosuccinate, Disodium Tallamido MEA-Sulfosuccinate, Disodium Tallowamido MEA-Sulfosuccinate, Disodium Tallow Sulfosuccinamate, Disodium Tridecylsulfosuccinate, Disodium Undecylenamido MEA-Sulfosuccinate, Disodium Undecylenamido PEG-2 Sulfosuccinate, Disodium Wheat Germamido MEA-Sulfosuccinate, Disodium Wheat Germamido PEG-2 Sulfosuccinate, Di-TEA-Oleamido PEG-2 Sulfosuccinate, Ditridecyl Sodium Sulfosuccinate, Sodium Bisglycol Ricinosulfosuccinate, Sodium/MEA Laureth-2 Sulfosuccinate and Tetrasodium Dicarboxyethyl Stearyl Sulfosuccinamate. Yet another suitable sulfosuccinamate is disodium C₁₆₋₁₈-alkoxypropylene sulfosuccinamate.

Preferred anionic sulfosuccinic acid surfactants are imidosuccinate, monosodium diisobutyl sulfosuccinate (Monawet® MB 45), monosodium dioctyl sulfosuccinate (Monawet® MO-84 R2W, Rewopol® SB DO 75), monosodium ditridecyl sulfosuccinate (Monawet® MT 70), fatty alcohol polyglycol sulfosuccinate sodium ammonium salt (Sulfosuccinat S-2), disodium mono-C_{12/14}-3EO sulfosuccinate (Texapon® SB-3), sodium sulfosuccinate diisooctyl (Texin® DOS 75) and disodium mono-C_{12/18} sulfosuccinate (Texin® 128-P).

Further useful anionic surfactants include fatty acid derivatives of amino acids, for example of N-methyltaurine (taurides) and/or of N-methylglycine (sarcosides). Especially preferred are the sarcosides or the sarcosinates and here in particular sarcosinates of higher and optionally mono- or polyunsaturated fatty acids such as oleyl sarcosinate.

Further useful anionic surfactants are in particular, soaps. Those suitable are saturated and unsaturated fatty acid soaps such as the salts of lauric acid, myristic acid, palmitic acid, stearic acid, hydrogenated erucic acid and behenic acid and also in particular soap mixtures derived from natural fatty acids, for example coconut, palm kernel or tallow fatty acids.

The anionic surfactants including the soaps may be present in the form of their sodium, potassium or ammonium salts, or else as soluble salts of organic bases, such as mono-, di- or triethanolamine. The anionic surfactants are preferably in the form of their sodium or potassium salts, in particular in the form of the sodium salts and/or in the form of their ammonium salts, in particular of their ammonium salts with at least one long-chain alkyl radical or alkanolamine radical on the ammonium nitrogen.

Suitable further anionic surfactants are also anionic Gemini surfactants having a diphenyl oxide basic structure, 2 sulfonate groups and one alkyl radical on one or both benzene rings in accordance with the formula ⁻O₃S(C₆H₃R)O(C₆H₃R′)SO₃⁻wherein R is an alkyl radical having, for example, 6, 10, 12 or 16 carbon atoms and R′ is R or H (Dowfax® Dry Hydrotrope Powder with C₁₆-alkyl radical(s); INCI Sodium Hexyldiphenyl Ether Sulfonate, Disodium Decyl Phenyl Ether Disulfonate, Disodium Lauryl Phenyl Ether Disulfonate, Disodium Cetyl Phenyl Ether Disulfonate) and fluorinated anionic surfactants, in particular perfluorinated alkylsulfonates such as ammonium C_{9/10}-perfluoroalkylsulfonate (Fluorad® FC 120) and perfluorooctanesulfonic acid potassium salt (Fluorad® FC 95).

The anionic surfactants are present in the inventive washing and/or cleaning articles, based on the total content of substance(s) and/or washing substances preferably in amounts of from 0 to 50% by weight, more preferably in amounts of from 5 to 40% by weight, particularly preferably in amounts of from 10 to 30% by weight and in particular in amounts of from 15 to 25% by weight.

Nonionic Surfactants

Suitable nonionic surfactants are, for example, C₆-C₂₂-alkyl alcohol polyglycol ethers, alkylpolyglycosides and also nitrogen-containing surfactants or else di-C₁-C₁₂-alkyl sulfosuccinates or mixtures thereof, in particular of the first two.

C₆-C₂₂-Alkyl alcohol polypropylene glycol/polyethylene glycol ethers constitute preferred known nonionic surfactants. They can be described by the formula I R¹O—(CH₂CH(CH₃)O)ₚ(CH₂CH₂O)ₑ—H, wherein R¹ is a linear or branched, aliphatic alkyl and/or alkenyl radical having from 6 to 22, preferably from 8 to 18, in particular from 10 to 16, carbon atoms, p is 0 or numbers from 1 to 3 and e is numbers from 1 to 20.

The C₆-C₂₂-alkyl alcohol polyglycol ethers of the formula I may be obtained by addition of propylene oxide and/or ethylene oxide to alkyl alcohols, preferably to oxo alcohols, the branched-chain primary alcohols obtainable by the oxo process, or to fatty alcohols, especially to fatty alcohols. Especially preferred are alcohol ethoxylates having linear radicals from alcohols of native origin having from 12 to 18 carbon atoms, for example from coconut, palm, tallow fat or oleyl alcohol and on average from 2 to 8 mol of EO per mole of alcohol. Typical examples are polyglycol ethers of the formula I wherein R¹ is an alkyl radical having from 8 to 18 carbon atoms, p is from 0 to 2 and e is numbers from 1 to 12, preferably from 2 to 7. The preferred ethoxylated alcohols include, for example, C₁₂₋₁₄ alcohols having 3 EO, 4 EO or 7 EO, C₉₋₁₁ alcohols having 7 EO, C₁₃₋₁₅ alcohols having 3 EO, 5 EO, 7 EO or 8 EO, alcohols having 3 EO, 5 EO or 7 EO and mixtures of these such as mixtures of C₁₂₋₁₄ alcohol having 3 EO and C₁₂₋₁₈ alcohol having 7 EO. Particular preferred representatives are, for example, C₁₀₋₁₄ fatty alcohol+1 PO+6 EO ether (p=1, e=6), C₁₂-C₁₆ fatty alcohol+5.5 EO (p=0, e=5.5), C₁₂-C₁₈ fatty alcohol+7 EO ether (p=0, e=7) and isodecanol+6 EO (R¹=isomer mixture of C₁₀ oxoalcohol radicals, p=0, e=6) and also mixtures thereof. In special mixtures, at least one representative of the formula I having a linear alkyl radical R¹ is combined with at least one representative of the formula I having a branched alkyl radical R¹, for example C₁₂-C₁₆ fatty alcohol+5.5 EO and isodecanol+6 EO. It is further preferred in this context that the linear alkyl radical has more carbon atoms than the branched alkyl radical. Particular preference is given to C₈ fatty alcohol+1.2 PO+8.4 EO, C₈₋₁₀ fatty alcohol+5 EO, C₁₂₋₁₄ fatty alcohol+6 EO and C₁₂₋₁₄ fatty alcohol+3 EO, and to mixtures thereof. The degrees of ethoxylation specified constitute statistical averages which may be an integer or a fraction for a specific product. Preferred alcohol ethoxylates have a narrow homolog distribution (narrow range ethoxylates, NRE). In addition to these nonionic surfactants, fatty alcohols having more than 12 EO may also be used. Examples thereof are tallow fatty alcohol having 14 EO, 25 EO, 30 EO or 40 EO. Nonionic surfactants which contain EO and PO groups together in the molecule can also be used in accordance with the invention. In this context, block copolymers having EO—PO block units or PO-EO block units may be used, but also EO—PO-EO copolymers or. PO-EO—PO copolymers. It will be appreciated that nonionic surfactants having mixed alkoxylation can also be used in which EO and PO units are not distributed in blocks but rather randomly. Such products are obtainable by simultaneous action of ethylene oxide and propylene oxide on fatty alcohols.

End group-capped C₆-C₂₂-alkyl alcohol polyglycol ethers may also be used, i.e. compounds in which the free OH group in the formula I has been etherified. The end group-capped C₆-C₂₂-alkyl alcohol polyglycol ethers may be obtained by relevant preparative organic chemistry methods. Preference is given to reacting C₆-C₂₂-alkyl alcohol polyglycol ethers in the presence of bases with alkyl halides, in particular butyl chloride or benzyl chloride. Typical examples are mixed ethers of the formula I wherein R¹ is a technical fatty alcohol radical, preferably C_{12/14}-cocoalkyl radical, p is 0 and e is from 5 to 10, and which are capped by a butyl group.

The nonionic surfactants used may also be, for example, alkoxylated, preferably ethoxylated or ethoxylated and propoxylated fatty acid alkyl esters, preferably having from 1 to 4 carbon atoms in the alkyl chain, in particular fatty acid methyl esters, as described, for example, in the Japanese patent application JP 58/217598 or which are preferably prepared by the process described in the International patent application WO 90/13533. Preferred nonionic surfactants are C₁₂-C₁₈ fatty acid methyl esters having on average from 3 to 15 EO, in particular having on average from 5 to 12 EO. In particular, C₁₂-C₁₈ fatty acid methyl esters having from 10 to 12 EO may be used as surfactants.

Alkylpolyglycosides (APG) are also particularly preferred sugar surfactants in the context of the inventive teaching and preferably satisfy the general formula R^{II}O(AO)ₐ[G]ₓ wherein R^{II} is a linear or branched, saturated or unsaturated alkyl radical having from 6 to 22, preferably from 6 to 18, in particular from 8 to 16, more preferably from 8 to 14, carbon atoms, [G] is a glycoside-attached sugar residue and x is a number from 1 to 10 and AO is an alkyleneoxy group, for example an ethyleneoxy or propyleneoxy group, and a is the average degree of alkoxylation of from 0 to 20. The (AO)ₐ group may also contain different alkyleneoxy units, for example ethyleneoxy or propyleneoxy units, in which case a is then the average total degree of alkoxylation, i.e. the sum of degree of ethoxylation and degree of propoxylation. Unless stated in more detail or otherwise hereinbelow, the alkyl radicals R^{II} of the APG are linear unsaturated radicals having the specified number of carbon atoms.

APGs are nonionic surfactants and constitute known substances which can be obtained by the relevant preparative organic chemistry methods. The index number x specifies the degree of oligomerization (average degree of polymerization), i.e. the distribution of mono- and oligoglycosides, and is a number between 1 and 10. While x in a given compound always has to be an integer and here in particular may assume the values x=from 1 to 6, the x value for a certain alkylglycoside is an analytically determined calculated parameter which is usually a fraction. Preference is given to using alkylglycosides having an average degree of oligomerization x of from 1.1 to 3.0. From an application point of view, preference is given to those alkylglycosides whose degree of oligomerization is less than 1.7 and is in particular between 1.2 and 1.6. The glycosidic sugars used are preferably xylose, but in particular glucose.

The alkyl or alkenyl radical R^{II} may derive from primary alcohols having from 8 to 18, preferably from 8 to 14, carbon atoms. Typical examples are caproic alcohol, caprylic alcohol, capric alcohol and undecyl alcohol and also their technical grade mixtures, as obtained, for example, in the course of the hydrogenation of technical-grade fatty acid methyl esters or in the course of the hydrogenation of aldehydes from the ROELEN oxo process.

However, the alkyl or alkenyl radical R^{II} preferably derives from lauryl alcohol, myristyl alcohol, cetyl alcohol, palmoleyl alcohol, stearyl alcohol, isostearyl alcohol or oleyl alcohol. Mention should also be made of elaidyl alcohol, petroselinyl alcohol, arachidyl alcohol, gadoleyl alcohol, behenyl alcohol, erucyl alcohol and their technical grade mixtures.

Particularly preferred APGs are not alkoxylated (α=0) and satisfy formula RO[G]ₓ wherein R, as before, is a linear or branched, saturated or unsaturated alkyl radical having from 4 to 22 carbon atoms, [G] is a glycoside-attached sugar radical, preferably glucose radical, and x is a number from 1 to 10, preferably from 1.1 to 3, in particular from 1.2 to 1.6. Accordingly, preferred alkylpolyglycosides are, for example, C₈₋₁₀- and a C₁₂₋₁₄-alkylpolyglycoside having an average degree of polymerization of 1.4 or 1.5, in particular C₈₋₁₀-alkyl 1,5-glucoside and C₁₂₋₁₄-alkyl 1,4-glucoside.

Nonionic surfactants of the amine oxide type and of the fatty acid alkanolamide type may also be suitable nonionic surfactants. The amine oxides suitable in accordance with the invention include alkylamine oxides, in particular alkyldimethylamine oxides, alkylamido amine oxides and alkoxyalkyl amine oxides. Preferred amine oxides satisfy formula II or III

R⁶R⁷R⁸N⁺—O⁻ (II)

R₆—[CO—NH—(CH₂)_{w}]_{z}—N⁺(R⁷)(R⁸)—O⁻ (III)

wherein

R⁶ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical which is bonded to the nitrogen atom N via a carbonylamido alkylene group —CO—NH—(CH₂)_{z}— in the alkylamido amine oxides and via an oxaalkylene group —O—(CH₂)_{z}— in the alkoxyalkyl amine oxides, where z is in each case a number from 1 to 10, preferably from 2 to 5, in particular 3,

R⁷, R⁸ are each independently a C₁₋₄-alkyl radical, optionally hydroxyl-substituted, for example a hydroxyethyl radical, in particular a methyl radical.

Examples of suitable amine oxides are the following compounds named in accordance with INCI: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C8-10 Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide. A preferred amine oxide is, for example, Cocamidopropylamine Oxide.

Sugar surfactants constitute further suitable nonionic surfactants. These are known surface-active compounds which include, for example, the sugar surfactant classes of the alkylglucose esters, aldobionamides, gluconamides (sugar acid amides), glyceramides, glyceroglycolipids, polyhydroxy fatty acid amide sugar surfactants (sugar amides) and alkylpolyglycosides, as described, for instance, in WO 97/00609 (Henkel Corporation) and the documents cited therein, to which reference is made in this regard and whose contents are incorporated into this application. In the context of the inventive teaching, preferred sugar surfactants are the alkylpolyglycosides and the sugar amides and also derivatives thereof, in particular their ethers and esters. The ethers are the products of the reaction of one or more, preferably one, sugar hydroxyl group with a compound containing one or more hydroxyl groups, for example C₁₋₂₂-alcohols or glycols such as ethylene glycol and/or propylene glycol, and the sugar hydroxyl group may also bear polyethylene glycol and/or polypropylene glycol radicals. The esters are the reaction products of one or more, preferably one, sugar hydroxyl group with a carboxylic acid, in particular a C₆₋₂₂ fatty acid.

Nonionic surfactants from the class of the sugar amides may equally be used. Particularly preferred sugar amides satisfy the formula R′C(O)N(R″)[Z] wherein R′ is a linear or branched, saturated or unsaturated acyl radical, preferably a linear, unsaturated acyl radical having from 5 to 21, preferably from 5 to 17, in particular from 7 to 15, more preferably from 7 to 13, carbon atoms, R″ is a linear or branched, saturated or unsaturated alkyl radical, preferably a linear, unsaturated alkyl radical having from 6 to 22, preferably from 6 to 18, in particular from 8 to 16, more preferably from 8 to 14, carbon atoms, a C₁₋₅-alkyl radical, in particular a methyl, ethyl, propyl, isopropyl, n-butyl, isobutyl, tert-butyl or n-pentyl radical, or hydrogen, and Z is a sugar residue, i.e. a monosaccharide residue. Particularly preferred sugar amides are the amides of glucose, the glucamides, for example lauroyl methyl glucamide.

Further suitable surfactants are polyhydroxy fatty acid amides of the formula IV

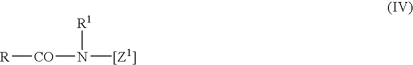

in which RCO is an aliphatic acyl radical having from 6 to 22 carbon atoms, R¹ is hydrogen, an alkyl or hydroxyalkyl radical having from 1 to 4 carbon atoms and [Z¹] is a linear or branched polyhydroxyalkyl radical having from 3 to 10 carbon atoms and from 3 to 10 hydroxyl groups. The polyhydroxy fatty acid amides are known substances which can be obtained typically by reductively aminating a reducing sugar with ammonia, an alkylamine or an alkanolamine and subsequently acylating with a fatty acid, a fatty acid alkyl ester or a fatty acid chloride.

The group of the polyhydroxy fatty acid amides also includes compounds of the formula V

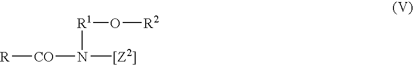

in which R is a linear or branched alkyl or alkenyl radical having from 7 to 12 carbon atoms, R¹ is a linear, branched or cyclic alkylene radical or an arylene radical having from 2 to 8 carbon atoms, and R² is a linear, branched or cyclic alkyl radical or an aryl radical or an oxyalkyl radical having from 1 to 8 carbon atoms, of which preference is given to C₁₋₄-alkyl or phenyl radicals, and [Z²] is a linear polyhydroxyalkyl radical whose alkyl chain is substituted by at least two hydroxyl groups, or alkoxylated, preferably ethoxylated or propoxylated, derivatives of this radical.

[Z²] is preferably obtained by reductively aminating a sugar, for example glucose, fructose, maltose, lactose, galactose, mannose or xylose. The N-alkoxy- or N-aryloxy-substituted compounds may then be converted to the desired polyhydroxy fatty acid amides, for example according to the teaching of International patent application WO 95/0733 1, by reacting with fatty acid methyl esters in the presence of an alkoxide as a catalyst.

The nonionic surfactants are present in the inventive washing and/or cleaning articles, based on the total content of substance(s) and/or washing substances preferably in amounts of from 0 to 15% by weight, more preferably in amounts of from 0.01 to 10% by weight and especially preferably in amounts of from 1 to 5% by weight.

Cationic Surfactants

The inventive composition may additionally comprise one or more cationic surfactants (INCI Quaternary Ammonium Compounds).

Preferred cationic surfactants are the quaternary surface-active compounds, especially having an ammonium, sulfonium, phosphonium, iodinium or arsonium group, which are antimicrobial substances as described, for example, by K. H. Wallhäusser in “Praxis der Sterilisation, Desinfektion—Konservierung: Keimidentifizierung—Betriebshygiene” [Practice of Sterilization, Disinfection—Preservation: Germ Identification—Workplace Hygiene] (5^{th} ed.—Stuttgart; New York: Thieme, 1995). The use of quaternary surface-active compounds having antimicrobial action may equip the composition with antimicrobial action or improve any antimicrobial action already present owing to other ingredients.

Particularly preferred cationic surfactants are quaternary, partly antimicrobially active ammonium compounds (QACs; INCI Quaternary Ammonium Compounds) of the general formula (R^{I})(R^{II})(R^{III})(R^{IV})N⁺X⁻ wherein R^{I} to R^{IV} are identical or different C₁₋₂₂-alkyl radicals, C₇₋₂₈-aralkyl radicals or heterocyclic radicals, in which two, or, in the case of an aromatic single bond as in pyridine, even three radicals, together with the nitrogen atom form the heterocycle, for example a pyridinium or imidazolinium compound, and X⁻are halide ions, sulfate ions, hydroxide ions or similar anions. For an optimum antimicrobial action, at least one of the radicals preferably has a chain length of from 8 to 18, in particular from 12 to 16, carbon atoms.

QACs can be prepared by reacting tertiary amines with alkylating agents, for example methyl chloride, benzyl chloride, dimethyl sulfate, dodecyl bromide, but also ethylene oxide. The alkylation of tertiary amines having a long alkyl radical and two methyl groups succeeds particularly readily, and the quaternization of tertiary amines having two long radicals and a methyl group may also be carried out with the aid of methyl chloride under mild conditions. Amines which have three long alkyl radicals or hydroxyl-substituted alkyl radicals have low reactivity and are preferably quaternized with dimethyl sulfate.

Suitable QACs are, for example, benzalkonium chloride (N-alkyl-N,N-dimethylbenzylammonium chloride, CAS No. 8001-54-5), benzalkone B (m,p-dichlorobenzyl-dimethyl-C₁₂-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1) and also mixtures thereof. Preferred QACs are the benzalkonium chlorides having C₈-C₁₈-alkyl radicals, in particular C₁₂-C₁₄-alkylbenzyldimethylammonium chloride. A particularly preferred QAC is cocopentaethoxymethylammonium methosulfate (INCI PEG-5 Cocomonium Methosulfate; Rewoquat® CPEM).

To avoid possible incompatibilities of the antimicrobial cationic surfactants with the anionic surfactants present in accordance with the invention, very substantially anionic surfactant-compatible and/or very little cationic surfactant is used, or, in a preferred embodiment of the invention, antimicrobially active cationic surfactants are entirely dispensed with. The antimicrobially active substances used may be parabens, benzoic acid and/or benzoate, lactic acid and/or lactates. Particular preference is given to benzoic acid and/or lactic acid.

The cationic surfactants are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 1% by weight.

Amphoteric Surfactants

The amphoteric surfactants (zwitterionic surfactants) which can be used in accordance with the invention include betaines, alkylamidoalkylamines, alkyl-substituted amino acids, acylated amino acids or biosurfactants, of which the betaines are preferred in the context of the inventive teaching.

Betaines

Suitable betaines are the alkylbetaines, the alkylamidobetaines, the imidazoliniumbetaines, the sulfobetaines (INCI Sultaines) and the phosphobetaines and preferably satisfy formula VI:

R¹—[CO—X—(CH₂)ₙ]ₓ—N⁺(R²)(R³—(CH₂)ₘ—[CH(OH)—CH₂]_{y}—Y⁻ (VI)

wherein R¹ is a saturated or unsaturated C₆₋₂₂-alkyl radical, preferably C₈-C₁₈-alkyl radical, in particular a saturated C₁₀₋₁₆-alkyl radical, for example a saturated C₁₂₋₁₄-alkyl radical,

X is NH, NR⁴ with the C₁₋₄-alkyl radical R⁴, O or S,

n is a number from 1 to 10, preferably from 2 to 5, in particular 3,

x is 0 or 1, preferably 1,

R², R³ are each independently C₁₋₄-alkyl radicals, optionally hydroxyl-substituted, for example, a hydroxyethyl radical, but in particular a methyl radical,

m is a number from 1 to 4, in particular 1, 2 or 3,

y is 0 or 1 and

Y is COO, SO₃, OPO(OR⁵)O or P(O)(OR⁵)O, where R⁵ is a hydrogen atom H or a C₁₋₄-alkyl radical.

The alkyl- and alkylamidobetaines, betaines of the formula VI having a carboxylate group (Y⁻═COO⁻), are also called carbobetaines.

Preferred amphoteric surfactants are the alkylbetaines of the formula (VIa), the alkylamidobetaines of the formula (VIb), the sulfobetaines of the formula (VIc) and the amidosulfobetaines of the formula (VId),

R¹—N⁺(CH₃)₂—CH₂COO⁻ (VIa)

R¹—CO—NH—(CH₂)₃—N⁺(CH₃)₂—CH₂COO⁻ (VIb)

R¹—N⁺(CH₃)₂—CH₂CH(OH)CH₂SO₃⁻ (VIc)

R¹—CO—NH—(CH₂)₃—N⁺(CH₃)₂—CH₂CH(OH)CH₂SO₃⁻ (VId)

wherein R¹ is as defined in formula VI.

Particularly preferred amphoteric surfactants are the carbobetaines, in particular the carbobetaines of the formula (VIa) and (VIb), preferably the alkylamidobetaines of the formula (VIb).

Examples of suitable betaines and sulfobetaines are the following compounds named in accordance with INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Camitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. A preferred betaine is, for example, Cocamidopropyl Betaine.

Alkylamidoalkylamines

The alkylamidoalkylamines (INCI Alkylamido Alkylamines) are amphoteric surfactants of the formula (VII),

R⁹—CO—NR¹⁰—(CH₂)ᵢ—N(R¹¹)—(CH₂CH₂O)ⱼ—(CH₂)ₖ—[CH(OH)]ₗ—CH₂-Z-OM (VII)

wherein:

R⁹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

R¹⁰ is a hydrogen atom H or a C₁₋₄-alkyl radical, preferably H,

i is a number from 1 to 10, preferably from 2 to 5, in particular 2 or 3,

R¹¹ is a hydrogen atom H or CH₂COOM (for M see below),

j is a number from 1 to 4, preferably 1 or 2, in particular 1,

k is a number from 0 to 4, preferably 0 or 1,

l is 0 or 1, where k=1 when l=1,

z is CO, SO₂, OPO(OR¹²) or P(O)(OR¹²), where R¹² is a C₁₋₄-alkyl radical or M (see below), and

M is hydrogen, an alkali metal, an alkaline earth metal or a protonated alkanolamine, e.g. protonated mono-, di- or triethanolamine.

Preferred representatives satisfy the formulae VIIa to VIId,

R⁹—CO—NH—(CH₂)₂—N(R¹¹)—CH₂CH₂O—CH₂—COOM (VIIa)

R⁹—CO—NH—(CH₂)₂—N(R¹¹)—CH₂CH₂O—CH₂CH₂—COOM (VIIb)

R⁹—CO—NH—(CH₂)₂—N(R¹¹)—CH₂CH₂O—CH₂CH(OH)CH₂—SO₃M (VIIc)

R⁹—CO—NH—(CH₂)₂—N(R¹¹)—CH₂CH₂O—CH₂CH(OH)CH₂—OPO₃HM (VIId)

wherein R¹¹ and M are each as defined in formula (VII).

Examples of alkylamidoalkylamines are the following compounds named in accordance with INCI: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipriopionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quatemium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Caprylo-amphopropionate, Sodium Cocoamphoacetate, Sodium Cocoamphohydroxypropylsulfonate, Sodium Cocoamphopropionate, Sodium Comamphopropionate, Sodium Isostearoamphoacetate, Sodium Isostearoamphopropionate, Sodium Lauroamphoacetate, Sodium Lauroamphohydroxy-propylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropyl-sulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Alkyl-Substituted Amino Acids

Alkyl-substituted amino acids (INCI Alkyl-Substituted Amino Acids) preferred in accordance with the invention are monoalkyl-substituted amino acids of formula (VIII),

R¹³—NH—CH(R¹⁴)—(CH₂)ᵤ—COOM′ (VIII)

wherein

R¹³ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

R¹⁴ is a hydrogen atom H or a C₁₋₄-alkyl radical, preferably H,

u is a number from 0 to 4, preferably 0 or 1, in particular 1, and

M′ is hydrogen, an alkali metal, an alkaline earth metal or a protonated alkanolamine, e.g. protonated mono-, di- or triethanolamine,

alkyl-substituted imino acids of formula (IX)

R¹⁵—N—[(CH₂)ᵥ—COOM″]₂ (IX)

wherein R¹⁵ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

v is a number from 1 to 5, preferably 2 or 3, in particular 2, and

M″ is hydrogen, an alkali metal, an alkaline earth metal or a protonated alkanolamine, e.g. protonated mono-, di- or triethanolamine, where M″ in the two carboxyl groups may have the same or two different definitions, for example may be hydrogen and sodium, or sodium twice, and monoalkyl- or dialkyl-substituted natural amino acids of formula (X),

R¹⁶—N(R¹⁷)—CH(R¹⁸)—COOM′″ (X)

wherein R¹⁶ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

R¹⁷ is a hydrogen atom or a C₁₋₄-alkyl radical, optionally hydroxy- or amine-substituted, e.g. a methyl, ethyl, hydroxyethyl or aminopropyl radical,

R¹⁸ is the radical of one of the 20 natural α-amino acids H₂NCH(R¹⁸)COOH, and

M′″ is hydrogen, an alkali metal, an alkaline earth metal or a protonated alkanolamine, e.g. protonated mono-, di- or triethanolamine.

Particularly preferred alkyl-substituted amino acids are the aminopropionates according to formula (VIIIa),

R¹³—NH—CH₂CH₂COOM′ (VIIIa)

wherein R¹³ and M′ are each as defined in formula (VIII).

Examples of alkyl-substituted amino acids are the following compounds named in accordance with INCI: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C12-15 Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristaminopropionate.

Acylated Amino Acids

Acylated amino acids are amino acids, in particular the 20 natural α-amino acids which bear the acyl radical R¹⁹CO of a saturated or unsaturated fatty acid R¹⁹COOH on the amino nitrogen atom where R¹⁹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical. The acylated amino acids may also be used as alkali metal salt, alkaline earth metal salt or alkanolammonium salt, e.g. mono-, di- or triethanolammonium salt. Examples of acylated amino acids are the acyl derivatives grouped under Amino Acids in accordance with INCI, e.g. Sodium Cocoyl Glutamate, Lauroyl Glutamic Acid, Capryloyl Glycine or Myristoyl Methylalanine.

Amphoteric surfactants are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 1% by weight.

Gemini Surfactants

Further useful surfactants are what are known as gemini surfactants. These generally refer to those compounds which have two hydrophilic groups and two hydrophobic groups per molecule. These groups are generally separated from each other by a spacer. This spacer is generally a carbon chain which should be sufficiently long that the hydrophilic groups have adequate separation so that they can act independently of the other. Such surfactants generally feature an unusually low critical micelle concentration and the ability to greatly reduce the surface tension of water. However, the term gemini surfactants refers in exceptional cases not only to dimeric, but also to trimeric surfactants.

Gemini surfactants for producing laundry detergents or cleaning compositions are, for example, sulfated mixed hydroxyethers according to the German patent application DE-A-43 21 022 or dimer alcohol bis- and trimer alcohol trissulfates and ether sulfates according to the German patent application DE-A-195 03 061. End group-capped dimeric and trimeric mixed ethers according to the German patent application DE-A-195 13 391 have the particular feature of their bi- and multifunctionality. For instance, the end group-capped surfactants mentioned have good wetting properties and are low-foaming, so that they are especially suitable for use in machine washing or cleaning processes.

Gemini surfactants are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 1% by weight.

Enzymes

In the case of the dry-formulated inventive washing and/or cleaning articles, preference is given to using coated enzyme granules.

Enzyme stabilizers are generally not needed when enzyme granules are used, but can be added. The coating of enzyme granules improves the storage stability and ensures safe handling of sensitizing enzymes. In contrast, enzyme stabilizers are typically used in liquid formulations.

Useful enzymes for use in the inventive washing and/or cleaning articles are in particular those from the classes of hydrolases, such as the proteases, esterases, oxidases, lipases and lipolytic enzymes, amylases, cellulases and other glycosyl hydrolases and mixtures of the enzymes mentioned. In the wash, the hydrolases contribute to the removal of marks, such as protein, grease or starch marks, and graying. Moreover, cellulases and other glycosyl hydrolases may, by removing pilling and microfibrils, contribute to color retention and to an increase in the softness of the textile. For bleaching or for inhibiting color transfer it is also possible to use oxireductases. Particularly suitable enzymatic active ingredients are those obtained from bacterial strains or fungi, such as Bacillus subtilis, Bacillus licheniformis, Streptomyceus griseus and Humicola insolens. Preference is given to using proteases of the subtilisin type and in particular proteases obtained from Bacillus lentus. Of particular interest for the inventive washing and/or cleaning article are enzyme mixtures, for example mixtures of protease and amylase or protease and lipase or lipolytic enzymes or protease and cellulase or mixtures of cellulase and lipase or lipolytic enzymes or mixtures of protease, amylase and lipase or lipolytic enzymes or protease, lipase or lipolytic enzymes and cellulase, but in particular protease and/or lipase-containing mixtures, or mixtures containing lipolytic enzymes. Examples of lipolytic enzymes of this kind are the known cutinases. Peroxidases or oxidases have also been found to be suitable in some cases. Suitable amylases include in particular α-amylases, isoamylases, pullulanases and pectinases. In addition to the aforementioned enzymes, cellulases are additionally useful for the inventive washing and/or cleaning article. The cellulases used are preferably cellobiohydrolases, endoglucanases and β-glucosidases, which are also called cellobiases, or mixtures thereof. Since different cellulase types differ in their CMCase and avicelase activities, it is possible to attain the desired activities by selective mixing of the cellulases.

Preference is given, for example, to proteases (e.g. BLAP (Henkel), Savinase (NOVO), Durazym (NOVO), Maxapemm, etc.), amylases (e.g. Fermamyl (NOVO), etc.), lipases (e.g. Lipolase (NOVO), etc.), peroxidases, gluconases, cellulases, mannases, etc.

The enzymes may be adsorbed on supports or embedded in coating substances in order to protect them against premature decomposition, or may also be embedded into the inventive supports.

The proportion of the enzymes, enzyme mixtures or enzyme granules may be, based on the total content of substance(s) and/or washing substances, for example, from about 0 to 5% by weight, preferably from 0.1 to 4% by weight, more preferably from 0.5 to 3% by weight and most preferably from 1.5 to 2% by weight.

Enzyme Stabilizers

The inventive washing and/or cleaning articles are preferably free of enzyme stabilizers, since the articles are preferably in solid form. The inventive washing and/or cleaning articles may also comprise enzyme stabilizers, but this is not obligatory. For example, sodium formate may be present. It is also possible to use proteases which are stabilized by soluble calcium salts and a calcium content of preferably about 1.2% by weight, based on the enzyme. Apart from calcium salts, magnesium salts also serve as stabilizers. However, it is particularly advantageous to use boron compounds, for example boric acid, boron oxide, borax and other alkali metal borates such as the salts of orthoboric acid (H3BO3), of metaboric acid (HBO2) and of pyroboric acid (tetraboric acid H2B4O7).

The proportion of enzyme stabilizers may be, for example, based on the total content of substance(s) and/or washing substances, for example, from about 0 to 10% by weight, preferably from 0.01 to 5% by weight.

Builders

The inventive washing and/or cleaning articles may comprise, as builders, any builders which are customarily used in laundry detergents or cleaning compositions, especially in laundry detergents, i.e. especially zeolites, silicates, carbonates, organic builders and cobuilders and also the phosphates. Particular preference is given to polymeric builders such as salts of polyacrylic acids.

Suitable crystalline, sheetlike sodium silicates have the general formula NaMSiₓO₂ₓ₊₁.H₂O where M is sodium or hydrogen, x is a number from 1.9 to 4 and y is a number from 0 to 20 and preferred values for x are 2, 3 or 4. Preferred crystalline sheet silicates of the formula specified are those in which M is sodium and x assumes the values 2 or 3. Preference is given in particular either to ss- or to δ-sodium disilicates Na₂Si₂O₅.yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6. Preference is given in particular to amorphous silicates.

A useful finely crystalline zeolite comprising synthetic and bound water is preferably zeolite A and/or P. The zeolite P is more preferably zeolite MAP® (commercial product from Crosfield). However, also suitable is zeolite X and also mixtures of A, X and/or P. Commercially available and useable with preference in the context of the present invention is also, for example, a cocrystal of zeolite X and zeolite A (approx. 80% by weight zeolite X) which is sold by CONDEA Augusta S.p.A. under the brand name VEGOBOND AX® and corresponds to the formula: nNa₂O.(1-n)K₂O.Al₂O₃.(2-2.5)SiO₂.(3.5-5.5)H₂O.

The zeolite may be used as a spray-dried powder or else as an undried, stabilized suspension which is still moist from its production. In the case that the zeolite is used as a suspension, the latter may contain small additions of nonionic surfactants as stabilizers, for example from 1 to 3% by weight, based on zeolite, of ethoxylated C₁₂-C₁₈ fatty alcohols having from 2 to 5 ethylene oxide groups, C₁₂-C₁₄ fatty alcohols having from 4 to 5 ethylene oxide groups or ethoxylated isotridecanols.

Suitable zeolites have an average particle size of less than 10 μm (volume distribution; analytical method: Coulter counter) and preferably contain from 18 to 22% by weight, in particular from 20 to 22% by weight, of bound water.

It will be appreciated that it is also possible to use the commonly known phosphates as builder substances, as long as such a use is not to be avoided for ecological reasons. Especially suitable are the sodium salts of orthophosphates, of pyrophosphates and in particular of tripolyphosphates.

The organic cobuilders present in the inventive washing and/or cleaning articles may in particular be polycarboxylates/polycarboxylic acids, polymeric polycarboxylates, aspartic acid, polyacetals, dextrins, further organic cobuilders (see below) and phosphonates. These substance classes are described below.

Useful organic builder substances are, for example, the polycarboxylic acids useable in the form of their sodium salts, polycarboxylic acids referring to those carboxylic acids that bear more than one acid function. For example, these are citric acid, adipic acid, succinic acid, glutaric acid, malic acid, tartaric acid, maleic acid, fumaric acid, sugar acids, aminocarboxylic acids, nitrilotriacetic acid (NTA), as long as there is no objection to such a use for ecological reasons, and also mixtures thereof. Preferred salts are the salts of polycarboxylic acids such as citric acid, adipic acid, succinic acid, glutaric acid, tartaric acid, sugar acids and mixtures thereof.

The acids themselves may also be used. In addition to their builder action, the acids typically also have the property of an acidifying component and thus also serve to establish a lower and milder pH of laundry detergents and/or cleaning compositions. Particular mention should be made in this context of citric acid, succinic acid, glutaric acid, adipic acid, gluconic acid and any mixtures thereof.

Very particularly preferred builders are also polymeric polycarboxylates. These are, for example, the alkali metal salts of polyacrylic acid or of polymethacrylic acid, for example those having a relative molecular mass of from 500 to 70 000 g/mol.

In this document, molar masses specified for polymeric polycarboxylates are weight-average molar masses M_{w} of the particular acid form which were always determined by means of gel-permeation chromatography (GPC), using a UV detector. The measurement was against an external polyacrylic acid standard which provided realistic molar mass values owing to its structural similarity to the polymers investigated. These data deviate distinctly from the molar mass data for which polystyrene sulfonic acids were used as a standard. The molar masses measured against polystyrene sulfonic acids are generally distinctly higher than the molar masses specified in this document.

Suitable polymers are in particular polyacrylates which preferably have a molecular mass of from 2000 to 20 000 g/mol. Owing to their superior solubility, preference from this group may be given in turn to the short-chain polyacrylates which have molar masses of from 2000 to 10 000 g/mol and more preferably from 3000 to 5000 g/mol.

Particularly suitable builders are composed of foamed, crosslinked polyacrylates having a degree of neutralization of from 80 to 100%. These crosslinked polyacrylates may be used as pulverulent solids, granules or as foamed sheetlike structures.

Polyacrylate salt builders may advantageously be used as an additive in the form of solids, in particular powders, fibers and/or granules, or as a support because their volume increases under wash conditions by ≧100 times, preferably ≧500 times and more preferably ≧1000 times, by hydrogel formation. The volume increase has the effect that the sandwich system, preferably apart from the support material, for example inert support material, disintegrates, i.e. falls apart, and is distributed very efficiently in the wash liquor. This leads to a performance increase of the sandwich. In addition, the hydrogel may have care action on fibers.

Also suitable are copolymeric polycarboxylates especially those of acrylic acid with methacrylic acid and of acrylic acid or methacrylic acid with maleic acid. It has been found that particularly suitable copolymers are of acrylic acid with maleic acid and contain from 50 to 90% by weight of acrylic acid and from 50 to 10% by weight of maleic acid. Their relative molecular mass, based on free acids, is generally from 2000 to 70 000 g/mol, preferably from 20 000 to 50 000 g/mol and in particular from 30 000 to 40 000 g/mol.

Particular preference is also given to biodegradable polymers composed of more than two different monomer units, for example those whose monomers are salts of acrylic acid and of maleic acid and also vinyl alcohol and vinyl alcohol derivatives or whose monomers are salts of acrylic acid and of 2-alkylallylsulfonic acid and also sugar derivatives.

Further preferred copolymers are those whose monomers are preferably acrolein and acrylic acid/acrylic acid salts or acrolein and vinyl acetate.

Further preferred builder substances include are polymeric aminodicarboxylic acids, their salts or their precursor substances. Particular preference is given to polyaspartic acids and their salts and derivatives which have not only cobuilder properties but also bleach-stabilizing action.

Further suitable builder substances are polyacetals which can be obtained by reacting dialdehydes with polyolcarboxylic acids which have from 5 to 7 carbon atoms and at least 3 hydroxyl groups. Preferred polyacetals are obtained from dialdehydes such as glyoxal, glutaraldehyde, terephthalaldehyde and their mixtures and from polyolcarboxylic acids such as gluconic acid and/or glucoheptonic acid.

Further suitable organic builder substances are dextrins, for example oligomers or polymers of carbohydrates which can be obtained by partial hydrolysis of starches. The hydrolysis may be carried out by customary, for example acid- or enzyme-catalyzed processes. The hydrolysis products preferably have average molar masses in the range from 400 to 500 000 g/mol. Preference is given to a polysaccharide having a dextrose equivalent (DE) in the range from 0.5 to 40, in particular from 2 to 30, DE being a common measure of the reducing action of a polysaccharide in comparison to dextrose which has a DE of 100. It is possible to use either maltodextrins having a DE of between 3 and 20 and dry glucose syrups having a DE of between 20 and 37, and also yellow dextrins and white dextrins having high molar masses in the range from 2000 to 30 000 g/mol.

The oxidized derivatives of such dextrins are their reaction products with oxidizing agents which are capable of oxidizing at least one alcohol function of the saccharide ring to the carboxylic acid function. A product oxidized at C₆ of the saccharide ring may be particularly advantageous.

A preferred dextrin is described in the British patent application 94 19 091. The oxidized derivatives of such dextrins are their reaction products with oxidizing agents which are capable of oxidizing at least one alcohol function of the saccharide ring to the carboxylic acid function. Such oxidized dextrins and processes for their preparation are disclosed, for example, by the European patent applications EP-A-0 232 202, EP-A-0 427 349, EP-A-0 472 042 and EP-A-0 542 496 and also the international patent applications WO-A-92/18542, WO-A-93/08251, WO-A-94/28030, WO-A-95/07303, WO-A-95/12619 and WO-A-95/20608. A product oxidized at C6 of the saccharide ring may be particularly advantageous.

Oxydisuccinates and other derivatives of disuccinates, preferably ethylenediamine disuccinate, are further suitable cobuilders. Ethylenediamine N,N′-disuccinate (EDDS) is preferably used in the form of its sodium or magnesium salts. Preference is further given in this connection also to using glycerol disuccinates and glycerol trisuccinates, as described, for example, in the U.S. patents U.S. Pat. No. 4,524,009, U.S. Pat. No. 4,639,325, in the European patent application EP-A-0 150 930 and the Japanese patent application JP 93/339896.

Further useful organic cobuilders are, for example, acetylated hydroxycarboxylic acids and salts thereof which may optionally also be present in lactone form and which contain at least 4 carbon atoms and at least one hydroxyl group and also a maximum of two acid groups. Such cobuilders are described, for example, in the international patent application WO-A-95/20029.

A further substance class having cobuilder properties is that of the phosphonates. These are in particular hydroxyalkane- or aminoalkanephosphonates. Among the hydroxyalkanephosphonates, 1-hydroxyethane-1,1-diphosphonate (HEDP) is of particular significance as a cobuilder. It is preferably used as the sodium salt, the disodium salt reacting at neutral pH and the tetrasodium salt reacting at alkaline pH (pH 9). Useful aminoalkanephosphonates are preferably ethylenediamine tetramethylenephosphonate (EDTMP), diethylenetriaminepentamethylene phosphonate (DTPMP) and their higher homologs. They are preferably used in the form of the sodium salts which react at neutral pH, for example as the hexasodium salt of EDTMP or as the hepta- and octasodium salt of DTPMP. The builder used is from the class of the phosphonates, preferably HEDP. The aminoalkanephosphonates additionally have marked heavy metal binding capability. Accordingly, it may be preferred, especially when the washing and/or cleaning articles also comprise bleaches, to use aminoalkanephosphonates, especially DTPMP, or mixtures of the phosphonates mentioned in the washing and/or cleaning articles.

In addition, all compounds which are capable of forming complexes with alkaline earth metal ions may be used as cobuilders.

Builders are present in the inventive washing and/or cleaning articles, based on the total content of substance(s) and/or washing substances, preferably in amounts of from 0 to 50% by weight, more preferably in amounts of from 10 to 40% by weight, particularly preferably in amounts of from 15 to 30% by weight and in particular in amounts of from 20 to 25% by weight.

Bleaches

The washing and/or cleaning articles may also comprise bleaches. Among the compounds which serve as bleaches and supply H₂O₂ in water, sodium perborate tetrahydrate and sodium perborate monohydrate are of particular significance. Examples of further useful bleaches are sodium percarbonate, peroxypyrophosphates, citrate perhydrates and H₂O₂-supplying peracidic salts or peracids, such as perbenzoates, peroxophthalates, diperazelaic acid, phthaloiminoperacid or diperdodecanedioic acid.

Bleaches from the group of organic bleaches may also be used in the inventive washing and/or cleaning articles. Typical organic bleaches are the diacyl peroxides, for example dibenzoyl peroxide. Further typical organic bleaches are the peroxy acids, particular examples being the alkylperoxy acids and the arylperoxy acids.

Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid) may be used in the inventive washing and/or cleaning articles.

Bleaches which may be used in the inventive washing and/or cleaning articles may also be substances which release chlorine or bromine. Among the suitable materials which release chlorine or bromine, useful examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Bleaches are present in the inventive washing and/or cleaning articles, based on the total content of substance(s) and/or washing substances, preferably in amounts of from 0 to 40% by weight, more preferably in amounts of from 10 to 30% by weight, particularly preferably in amounts of from 15 to 30% by weight and in particular in amounts of from 20 to 25% by weight.

Bleach Activators

In order to achieve enhanced bleaching action in the course of washing or cleaning at temperatures of 60° C. and below, bleach activators may be present.

Bleach activators which can be used in the inventive washing and/or cleaning articles are compounds which, under perhydrolysis conditions, give aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC).

In addition to the conventional bleach activators, or instead of them, bleach catalysts may also be incorporated into the inventive washing and/or cleaning articles. These substances are bleach-boosting transition metal salts or transition metal complexes, for example Mn—, Fe—, Co—, Ru—or Mo-salen complexes or -carbonyl complexes. Mn, Fe, Co, Ru, Mo, Ti, V and Cu complexes with N-containing tripod ligands, and Co—, Fe—, Cu—and Ru-ammine complexes can also be used as bleach catalysts.

The bleach activators used in the inventive washing and/or cleaning articles may also be the enol esters disclosed by the German patent applications DE-A-196 16 693 and DE-A-196 16 767, and also acetylated sorbitol and mannitol or their mixtures described in the European patent application EP-A-0 525 239 (SORMAN), acylated sugar derivatives, in particular pentaacetyl glucose (PAG), pentaacetyl fructose, tetraacetyl xylose and octaacetyl lactose, and also acetylated, optionally N-alkylated glucamine and gluconolactone and/or N-acylated lactams, for example N-benzoylcaprolactam, which are disclosed by the international patent applications WO-A-94/27970, WO-A-94/28102, WO-A-94/28103, WO-A-95/00626, WO-A-95/14759 and WO-A-95/17498. The hydrophilically substituted acyl acetals disclosed by the German patent application DE-A-196 16 769 and the acyl lactams described in the German patent application DE-A-196 16 770 and the international patent application WO-A-95/14075 are likewise used with preference in the inventive washing and/or cleaning articles. The combinations of conventional bleach activators disclosed by the German patent application DE-A-44 43 177 may also be used in the inventive washing and/or cleaning articles.

Bleach activators and/or bleach catalysts are present in the inventive washing and/or cleaning articles, based on the total content of substance(s) and/or washing substances, preferably in amounts of from 0 to 10% by weight, more preferably in amounts of from 0.1 to 8% by weight and especially preferably in amounts of from 5 to 8% by weight.

Color Transfer Inhibitors

Color transfer inhibitors are present in the inventive washing and/or cleaning articles, based on the total content of substance(s) and/or washing substances, preferably in amounts of from 0 to 5% by weight, more preferably in amounts of from 0.01 to 4% by weight, particularly preferably in amounts of from 0.25 to 2.5% by weight and in particular in amounts of from 0.5 to 0.75% by weight.

Graying Inhibitors

The washing and/or cleaning articles may also comprise graying inhibitors. Graying inhibitors have the task of keeping the soil detached from the fiber suspended in the liquor and thus preventing the soil from redepositing. Suitable for this purpose are water-soluble colloids, usually of organic nature, for example the water-soluble salts of polymeric carboxylic acids, size, gelatin, salts of ether carboxylic acids or ether sulfonic acids of starch or of cellulose or salts of acidic sulfuric esters of cellulose or of starch. Water-soluble polyamides containing acidic groups are also suitable for this purpose. It is also possible to use soluble starch preparations and starch products other than those mentioned above, for example degraded starch, aldehyde starches, etc. Polyvinylpyrrolidone can also be used. However, preference is given to using cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof, and also polyvinylpyrrolidone in the inventive washing and/or cleaning articles.

Graying inhibitors are present in the inventive washing and/or cleaning articles, based on the total content of substance(s) and/or washing substances, preferably in amounts of from 0 to 5% by weight, more preferably in amounts of from 0.01 to 4% by weight, particularly preferably in amounts of from 0.25 to 2.5% by weight and in particular in amounts of from 0.5 to 0.75% by weight.

Soil-Repellent Substances

In addition, soil-repellent substances which have a positive influence on the ability of oil and grease to be washed out of textiles (known as soil repellents) may also be used in the inventive washing and/or cleaning articles. The preferred oil- and grease-dissolving components include, for example, nonionic cellulose ethers such as methylcellulose and methylhydroxypropylcellulose having a proportion of methoxy groups of from 15 to 30% by weight and of hydroxypropoxy groups of from 1 to 15% by weight, based in each case on the nonionic cellulose ethers, and also the prior art polymers of phthalic acid and/or of terephthalic acid or derivatives thereof, in particular polymers of ethylene terephthalates and/or polyethylene glycol terephthalates or anionically and/or nonionically modified derivatives thereof.

Soil-repellent substances are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 2% by weight.

Optical Brighteners

These substances which are also known as “whiteners” may be used in the inventive washing and/or cleaning articles. Optical brighteners are organic dyes which convert some of the invisible UV radiation of sunlight to longer-wavelength blue light. The emission of this blue light fills the “gap” in the light reflected by the textile, so that a textile treated with optical brightener appears whiter and brighter to the eye. Since the mechanism of action of brighteners has the prerequisite of attachment to the fibers, a distinction is drawn, for example, between brighteners for cotton, polyamide or polyester fibers depending on the fibers to be “colored”. The commercial brighteners suitable for the inventive washing and/or cleaning articles include substantially five structural groups, i.e. the stilbene, diphenylstilbene, coumarin-quinoline, diphenylpyrazoline group and the group of the combination of benzoxazole or benzimidazole with conjugated systems. A review of common brighteners can be found, for example, in G. Jakobi, A. Löhr “Detergents and Textile Washing”, VCH-Verlag, Weinheim, 1987, pages 94 to 100. Suitable are, for example, salts of 4,4′-bis[(4-anilino-6-morpholino-s-triazin-2-yl)-amino]stilbene-2,2′-disulfonic acid or compounds of similar structure which, instead of the morpholino group, have a diethanolamino group, a methylamino group, an anilino group or a 2-methoxyethylamino group. In addition, brighteners of the substituted diphenylstyryl type may be present, for example the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the aforementioned brighteners may also be used.

Optical brighteners are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 2% by weight.

Fragrances

Fragrances can be added to the inventive washing and/or cleaning articles in order to improve the esthetic impression of the inventive washing and/or cleaning articles and to provide the consumer with cleaning performance and color impression coupled with a sensorily “typical and unmistakable” washing and/or cleaning article. Perfume oils or fragrances which may be used are individual odorant compounds, e.g. the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether, the aldehydes include, for example, the linear alkanals having 8-18 carbon atoms, citral, citronellal, citronellyloxyacetaldehyde, cyclamenaldehyde, hydroxycitronellal, lilial and bourgeonal, the ketones include, for example, the ionones, α-isomethylionone and methyl cedryl ketone, the alcohols include anethol, citronellol, eugenol, geraniol, linalool, phenylethyl alcohol and terpineol, and the hydrocarbons include primarily the terpenes, such as limonene and pinene. Preference is, however, given to using mixtures of different odorants in the inventive washing and/or cleaning articles which together produce a pleasing fragrance note. Such perfume oils can also contain natural odorant mixtures, as obtainable from plant sources, e.g. pine oil, citrus oil, jasmine oil, patchouli oil, rose oil and ylang ylang oil. Likewise suitable are muscatel, sage oil, camomile oil, oil of cloves, melissa oil, mint oil, cinnamon leaf oil, lime blossom oil, juniperberry oil, vetiver oil, olibanum oil, galbanum oil and labdanum oil, and orange blossom oil, neroliol, orange peel oil and sandalwood oil.

Fragrances are present in the inventive washing and/or cleaning articles, based on the total content of substance(s) and/or washing substances, preferably in amounts of from 0 to 5% by weight, more preferably in amounts of from 0 to 4% by weight, particularly preferably in amounts of from 0.01 to 1% by weight and in particular in amounts of from 0.2 to 0.5% by weight.

Fabric Softeners

Further substances or washing substances which can be used in the inventive cleaning articles are fabric softeners. In general, any of the fabric-softening substances disclosed by the prior art may be used. However, preference is given to quaternary ammonium compounds which, owing to their positive charge, have an affinity for cellulose-based textiles and, owing to their alkyl side chains, have affinity for artificial fiber textiles. Particularly suitable are cationic quaternary ammonium compound, for example polyethoxylated quaternary ammonium salts.

The quaternary ammonium compound preferably has an alkyl side chain having from about 8 to 20 carbon atoms. In addition, the quaternary ammonium compound should have one or more polyethoxy or polypropoxy side chains which are sufficiently long to keep a 1% solution of the quaternary ammonium compound soluble at about 25° C. Substituents on the nitrogen which are not alkyl side chains having from about 8 to 20 carbon atoms or polyethoxy or polypropoxy side chains may be methyl, ethyl, hydroxymethyl or hydroxyethyl groups. For example, quaternary cocoalkylammonium ethoxylates such as VARISOFT 910 (Witco Chemical Co.), quaternary tallow alkylammonium ethoxylates such as VARISOFT 920, PEG-2 cocoammonium chlorides such as VARIQUAT 638 and ETHOQUAD C-12 may be used. The quaternary fabric softener should preferably form reversible complexes with anionic surfactants and, when a mixture of the quaternary fabric softener and of the anionic surfactant has dissolved sufficiently, the fabric softener and the anionic surfactant should separate again.

Fabric softeners are present in the inventive washing and/or cleaning articles, based on the total content of substance(s) and/or washing substances, preferably in amounts of from 0 to 5% by weight, more preferably in amounts of from 0 to 3% by weight and especially preferably in amounts of from 0 to 1% by weight.

Disintegration Assistants

It is actually unnecessary in principle to use disintegration assistants in the inventive washing and/or cleaning articles. However, in order to promote better dissolution of the layers, it is also possible, if desired, nevertheless to add small amounts or, if required, even larger amounts of disintegration assistants. These normally serve to ease the disintegration of laundry detergents or cleaning compositions in solid form. According to Römpp (9^{th} Edition, Vol. 6, p. 4440) and Voigt “Lehrbuch der pharmazeutischen Technologie” [Textbook of Pharmaceutical Technology] (6^{th} Edition, 1987, p. 182-184), tablet disintegrants or disintegration accelerants refer to assistants which ensure rapid disintegration of tablets in water or gastric fluid and the release of the pharmaceuticals in absorbable form.

These substances which are also referred to as “break-up” agents owing to their action increase their volume when water enters, and it is either the increase in the intrinsic volume (swelling) or the release of gases to generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and their derivatives, alginates or casein derivatives.

The foamed, crosslinked polyacrylate builders which have already been described in the Builders section may likewise be used as disintegration assistants.

The three-dimensional network of the hydrophilic but water-insoluble polymer swells in water while substantially retaining its shape up to an equilibrium volume. The mechanical actions in the wash drum cause the network to disintegrate. Owing to the cobuilder properties of polyacrylate, the foamed, crosslinked polyacrylate builder leads to an increase in performance. The foamed, crosslinked polyacrylate builders may be used as a powder or granule, preferably as a sheetlike structure and in particular as a support.

The gels which form three-dimensional networks by swelling of hydrophilic, especially water-insoluble polymers are referred to as hydrogels. The network is formed predominantly via chemical linkage of the individual polymer chains, but is also possible physically by electrostatic, hydrophobic or dipole/dipole interactions between individual segments of the polymer chains. The selection of the monomers used to build the polymer, the type of crosslinking and the crosslinking density may be used in a selective manner to attain desired properties of the hydrogels. The necessary hydrophilicity of the polymers is imparted, inter alia, by hydroxyl, carboxylate, sulfonate or amide groups. Synthetic hydrogels are based, inter alia, on poly(meth)acrylic acids, poly(meth)acrylates, polyvinylpyrrolidone or polyvinyl alcohol. Hydrogels are generally highly compatible with living tissues.

In the context of the present invention, the preferred disintegrants used which are suitable in the inventive washing and/or cleaning articles are disintegrants based on cellulose. Pure cellulose has the formal empirical composition (C₆H₁O₅)ₙ and, viewed in a formal sense, is a β-1,4-polyacetal of cellobiose which is itself formed from two molecules of glucose. Suitable celluloses consist of from approx. 500 to 5000 glucose units and accordingly have average molar masses of from 50 000 to 500 000. In the context of the present invention, useful disintegrants based on cellulose are also cellulose derivatives which are obtainable from cellulose by polymer-like reactions. Such chemically modified celluloses include, for example, products from esterifications or etherifications in which hydroxyl hydrogen atoms have been substituted. However, celluloses in which the hydroxyl groups have been replaced by functional groups which are not bonded via an oxygen atom can also be used as cellulose derivatives. The group of cellulose derivatives includes, for example, alkali metal celluloses, carboxymethyl celluloses (CMC), cellulose esters and ethers and also amino celluloses. The cellulose derivatives mentioned are preferably not used alone as a disintegrant based on cellulose, but rather in a mixture with cellulose. The content of cellulose derivatives in these mixtures is preferably below 50% by weight, more preferably below 20% by weight, based on the disintegrant based on cellulose.

As a further disintegrant based on cellulose for use in the inventive washing and/or cleaning articles, microcrystalline cellulose may be used. This microcrystalline cellulose is obtained by partial hydrolysis of celluloses under conditions such that only the amorphous regions (approx. 30% of the overall cellulose mass) of the celluloses are attacked and fully dissolved, but the crystalline regions (approx. 70%) are left undamaged.

Disintegrants are present in the inventive washing and/or cleaning articles, based on the total content of substance(s) and/or washing substances, preferably in amounts of from 0 to 20% by weight, more preferably in amounts of from 0 to 15% by weight, and especially preferably in amounts of from 0 to 8% by weight.

Dyes

In order to improve the esthetic impression of the inventive washing and/or cleaning articles, they may be colored using suitable dyes. For example, the different layers may be colored differently. Preferred dyes, whose selection presents no difficulty whatsoever to those skilled in the art, have high storage stability and insensitivity toward the remaining ingredients of the washing and/or cleaning article and toward light, and also no marked substantivity toward textile fibers in order not to color them.

In the inventive washing and/or cleaning articles, preference is given to any colorants which can be oxidatively destroyed in the wash process, and also to mixtures thereof with suitable blue dyes, known as bluing agents. It has been found to be advantageous to use colorants in the inventive washing and/or cleaning articles that are soluble in water or at room temperature in liquid organic substances. Suitable are, for example, anionic colorants, for example anionic nitroso dyes. One possible colorant is, for example, Naphthol Green (Colour Index (CI) Part 1: Acid Green 1; Part 2: 10020) which is obtainable as a commercial product, for example, as Basacid® Green 970 from BASF, Ludwigshafen, and also mixtures thereof with suitable blue dyes. Further colorants which can be used include Pigmosol® Blue 6900 (CI 74160), Pigmosol® Green 8730 (CI 74260), Basonyl® Red 545 FL (CI 45170), Sandolan® Rhodamine EB400 (CI 45100), Basacid® Yellow 094 (CI 47005), Sicovit® Patent Blue 85 E 131 (CI 42051), Acid Blue 183 (CAS 12217-22-0, CI Acidblue 183), Pigment Blue 15 (CI 74160), Supranol® Blue GLW (CAS 12219-32-8, CI Acidblue 221), Nylosan® Yellow N-7GL SGR (CAS 61814-57-1, CI Acidyellow 218) and/or Sandolan® Blue (CI Acid Blue 182, CAS 12219-26-0).

In the selection of the colorant, care has to be taken that the colorant does not have too strong an affinity for the textile surfaces and here in particular for artificial fibers. At the same time, it has to be taken into account in the selection of suitable colorants that colorants have different stabilities toward the oxidation. In general, it is the case that water-insoluble colorants are more stable toward oxidation than water-soluble colorants. Depending on the solubility and thus also on the oxidation sensitivity, the concentration of the colorant in the washing and/or cleaning articles varies. In the case of highly water-soluble colorants, for example the abovementioned Basacid® Green, or Sandolan® Blue, likewise mentioned above, colorant concentrations in the range from a few 10⁻² to 10⁻³% by weight are selected, based in each case on the entire washing and/or cleaning article. In the case of the pigment dyes which are especially preferred as a consequence of their brilliance but are less readily water soluble, for example the abovementioned Pigmosol® dyes, the suitable concentration of the colorant in laundry detergents or cleaning compositions is, in contrast, typically a few 10⁻³ to 10⁻⁴% by weight, based on the entire laundry detergent or cleaning composition.

Dyes are present in the inventive washing and/or cleaning articles, based on the total content of substance(s) and/or washing substances, preferably in amounts of from 0 to 0.5% by weight, more preferably in amounts of from 0 to 0.1% by weight and especially preferably in amounts of from 0.005 to 0.02% by weight.

Solubility Enhancers

According to the invention, the amounts in which the solubility enhancers mentioned are present in the washing and/or cleaning article are between 0.5 and 20% by weight, based in each case on the washing and/or cleaning article weight. Preferred washing and/or cleaning articles in the context of the present invention contain the solubility enhancer(s) in amounts of from 1 to 15% by weight, preferably from 1.5 to 10% by weight and in particular from 2 to 5% by weight, based on the washing and/or cleaning article weight.

Preference is given in accordance with the invention to the solubility enhancers present in the inventive washing and/or cleaning article having a solubility of more than 250 g per liter of water at 20° C., preferably of more than 300 g per liter of water at 20° C. and in particular of more than 350 g per liter of water at 20° C.

Preference is also given to at least 35% by weight, preferably at least 40% by weight, more preferably at least 45% by weight and in particular at least 50% by weight of the particles of the solubilizer having particle sizes below 200 μm. The particle size range in which the particle sizes of the solubility enhancers present in the inventive washing and/or cleaning article are located preferably has an upper limit and is preferably within tight limits. Thus, preference is given to the laundry detergent and cleaning composition tablets in which a maximum of 20% by weight, preferably a maximum of 10% by weight and in particular a maximum of 5% by weight of the particles of the solubilizer have particle sizes of above 400 μm.

The solubility enhancers present in the washing and/or cleaning article in accordance with the invention have solubilities of above 200 grams of solubility enhancer in one liter of deionized water at 20° C. Suitable finely divided solubility enhancers in the context of the present invention are a whole series of compounds which may stem both from the group of covalent compounds and from the group of salts. As already mentioned, it is preferred for the solubility enhancers to have even higher solubilities. An overview of the solubilities of suitable solubility enhancers in the context of the present invention is given by the list which follows in TABLE 2. The solubility values reported in this table relate, unless other temperatures are stated explicitly, to the solubility at 20° C.

TABLE 2

| Compound | Solubility | |
|---|---|---|
| Sodium carbonate monohydrate | 210 | g/l |
| Sodium carbonate decahydrate | 210 | g/l |
| Lactose monohydrate (25° C.) | 216 | g/l |
| Disodium hydrogen phosphate dodecahydrate | 218 | g/l |
| Potassium dihydrogen phosphate | 222 | g/l |
| Potassium hydrogen carbonate | 224 | g/l |
| Sodium dithionite | 224 | g/l |
| Fumaric acid disodium salt (25° C.) | 228 | g/l |
| Calcium levulinate | 250 | g/l |
| Glycine (25° C.) | 250 | g/l |
| Potassium monopersulfate | 256 | g/l |
| Trisodium phosphate dodecahydrate | 258 | g/l |
| Ammonium iron(II) sulfate hexahydrate | 269 | g/l |
| Magnesium sulfate | 269 | g/l |
| Potassium hexacyanoferrate(II) trihydrate (12° C.) | 270 | g/l |
| Disodium tartrate dihydrate | 290 | g/l |
| Calcium acetate hydrate | 300 | g/l |
| Potassium hexacyanoferrate(III) | 315 | g/l |
| Potassium nitrate | 320 | g/l |
| Manganese(II) acetate tetrahydrate | 330 | g/l |
| L(+)-Ascorbic acid | 333 | g/l |
| Potassium chloride | 340 | g/l |
| Lithium sulfate monohydrate | 340 | g/l |
| Zinc sulfate monohydrate | 350 | g/l |
| Dipotassium oxalate monohydrate | 360 | g/l |
| Sodium chloride | 360 | g/l |
| L-(−)-Malic acid | 363 | g/l |
| Sodium bromate | 364 | g/l |
| Ammonium chloride | 370 | g/l |
| Ammonium dihydrogen phosphate | 370 | g/l |
| Iron(II) sulfate heptahydrate | 400 | g/l |
| Sodium azide (17° C.) | 417 | g/l |
| L-Lysine monohydrochloride | 420 | g/l |
| Magnesium nitrate hexahydrate | 420 | g/l |
| Zinc acetate dihydrate | 430 | g/l |
| Potassium hydrogen sulfate | 490 | g/l |
| Sodium acetate | 490 | g/l |
| Sodium sulfite (40° C.) | 495 | g/l |
| Magnesium perchlorate hydrate (25° C.) | 500 | g/l |
| Lithium nitrate | 522 | g/l |
| β-Alanine (25° C.) | 545 | g/l |
| L-(−)-Sorbose (17° C.) | 550 | g/l |
| Sodium peroxodisulfate | 556 | g/l |
| Sodium thiocyanate | 570 | g/l |
| Ammonium peroxodisulfate | 582 | g/l |
| Gluconic acid sodium salt (25° C.) | 590 | g/l |
| Ammonium bromide | 598 | g/l |
| Aluminum sulfate 18-hydrate | 600 | g/l |
| Aluminum sulfate hydrate (16-18 H₂O) | 600 | g/l |
| Potassium sodium tartrate tetrahydrate | 630 | g/l |
| Potassium bromide | 650 | g/l |
| Sodium hydrogen sulfate monohydrate | 670 | g/l |
| D(+)-Galactose (25° C.) | 680 | g/l |
| Sodium thiosulfate pentahydrate | 680 | g/l |
| Diammonium hydrogen phosphate | 690 | g/l |
| Magnesium sulfate heptahydrate | 710 | g/l |
| Calcium chloride | 740 | g/l |
| Trilithium citrate tetrahydrate (25° C.) | 745 | g/l |
| Ammonium sulfate | 760 | g/l |
| Manganese(II) sulfate monohydrate | 762 | g/l |
| Maleic acid (25° C.) | 788 | g/l |
| Ammonium carbamate | 790 | g/l |
| Sodium bromide | 790 | g/l |
| D(+)-Glucose monohydrate (25° C.) | 820 | g/l |
| Lithium chloride | 820 | g/l |
| Sodium formate | 820 | g/l |
| Saccharin sodium salt hydrate | 830 | g/l |
| Sodium nitrate | 880 | g/l |
| Tripotassium phosphate heptahydrate | 900 | g/l |
| Sodium sulfate decahydrate | 900 | g/l |
| Iron(III) chloride | 920 | g/l |
| Iron(III) chloride hexahydrate | 920 | g/l |
| Trisodium citrate 5.5-hydrate (25° C.) | 920 | g/l |
| Zinc sulfate heptahydrate | 960 | g/l |
| Ammonium carbonate | 1000 | g/l |
| Calcium chloride dihydrate | 1000 | g/l |
| Sodium chlorate | 1000 | g/l |
| Sodium polyphosphate | 1000 | g/l |
| Sodium salicylate | 1000 | g/l |
| Resorcinol | 1000 | g/l |
| Urea | 1080 | g/l |
| Sodium hydroxide | 1090 | g/l |
| Sodium dihydrogen phosphate monohydrate | 1103 | g/l |
| Potassium hydroxide | 1120 | g/l |
| Ammonium nitrate | 1183 | g/l |
| Sodium acetate trihydrate | 1190 | g/l |
| Ammonium iron(III) citrate | 1200 | g/l |
| Manganese(II) chloride dihydrate | 1200 | g/l |
| Ammonium iron(III) sulfate dodecahydrate (25° C.) | 1240 | g/l |
| Potassium iodide | 1270 | g/l |
| Malonic acid | 1390 | g/l |
| Manganese(II) chloride | 1400 | g/l |
| DL-Malic acid (26° C.) | 1440 | g/l |
| Ammonium acetate | 1480 | g/l |
| Iron(II) chloride tetrahydrate (10° C.) | 1600 | g/l |
| Dipotassium hydrogen phosphate | 1600 | g/l |
| Citric acid monohydrate | 1630 | g/l |
| Ammonium thiocyanate (19° C.) | 1650 | g/l |
| Tripotassium citrate monohydrate (25° C.) | 1670 | g/l |
| Magnesium chloride hexahydrate | 1670 | g/l |
| Ammonium iodide | 1700 | g/l |
| Cesium sulfate | 1790 | g/l |
| Sodium iodide | 1790 | g/l |
| Cesium chloride | 1800 | g/l |
| Zinc nitrate hexahydrate | 1800 | g/l |
| Zinc nitrate tetrahydrate | 1800 | g/l |
| Ammonium amidosulfonate | 1950 | g/l |
| Sucrose (15° C.) | 1970 | g/l |
| Manganese(II) chloride tetrahydrate | 1980 | g/l |
| Dipotassium tartrate hemihydrate | 2000 | g/l |
| Sodium perchlorate monohydrate (15° C.) | 2090 | g/l |
| Potassium thiocyanate | 2170 | g/l |
| D(+)-Mannose (17° C.) | 2480 | g/l |
| Melibiose monohydrate (25° C.) | 2500 | g/l |
| Potassium acetate | 2530 | g/l |
| Cesium carbonate | 2615 | g/l |
| Zinc chloride | 3680 | g/l |
| D(−)-Fructose | 3750 | g/l |
| Manganese(II) nitrate tetrahydrate | 3800 | g/l |
| Zinc iodide | 4500 | g/l |
| Calcium chloride hexahydrate | 5360 | g/l |

Further solubility enhancers which are preferred in the context of the present invention are the following substances in TABLE 3.

TABLE 3

| Compound | Solubility |
|---|---|
| Sodium carbonate monohydrate, | 210 g/l |
| sodium carbonate decahydrate | |
| Disodium hydrogen phosphate dodecahydrate | 218 g/l |
| Potassium dihydrogen phosphate | 222 g/l |
| Potassium hydrogen carbonate | 224 g/l |
| Fumaric acid disodium salt (25° C.) | 228 g/l |
| Potassium monopersulfate | 256 g/l |
| Trisodium phosphate dodecahydrate | 258 g/l |
| L(+)-Ascorbic acid | 333 g/l |
| Dipotassium oxalate monohydrate | 360 g/l |
| L-(−)-Malic acid | 363 g/l |
| Ammonium dihydrogen phosphate | 370 g/l |
| Potassium hydrogen sulfate | 490 g/l |
| Sodium acetate | 490 g/l |
| Sodium peroxodisulfate | 556 g/l |
| Ammonium peroxodisulfate | 582 g/l |
| Gluconic acid sodium salt (25° C.) | 590 g/l |
| Sodium hydrogen sulfate monohydrate | 670 g/l |
| Diammonium hydrogen phosphate | 690 g/l |
| Trisodium citrate dehydrate (25° C.) | 720 g/l |
| Maleic acid (25° C.) | 788 g/l |
| Tripotassium phosphate heptahydrate | 900 g/l |
| Trisodium citrate 5.5-hydrate (25° C.) | 920 g/l |
| Ammonium carbonate | 1000 g/l |
| Sodium polyphosphate | 1000 g/l |
| Sodium dihydrogen phosphate monohydrate | 1103 g/l |
| Sodium acetate trihydrate | 1190 g/l |
| Malonic acid | 1390 g/l |
| DL-Malic acid (26° C.) | 1440 g/l |
| Dipotassium hydrogen phosphate | 1600 g/l |
| Citric acid monohydrate | 1630 g/l |
| Tripotassium citrate monohydrate (25° C.) | 1670 g/l |
| Dipotassium tartrate hemihydrate | 2000 g/l |
| Potassium acetate | 2530 g/l |
| Cesium carbonate | 2615 g/l |

The inventive use of the solubility enhancers in the specified particle size range, optionally supported by the use of disintegration assistants, allows inventive laundry detergent and cleaning composition articles to be produced which, in the case of high hardnesses in water, disintegrate extremely rapidly into their constituents.

Plasticizing Assistants/Binders

These plasticizing assistants, referred to hereinbelow as binders, also include those which can serve as plasticizers and/or lubricants according to the European patent EP-B-0 486 592. These include in particular anionic surfactants such as alkylbenzenesulfonates and/or (fatty) alkyl sulfates, but also polymers such as polymeric polycarboxylates. There is a more precise description of the possible anionic surfactants and polymers in the list of the possible ingredients. The function of a lubricant may additionally also be assumed by the binder or the binders or the binder mixtures.

The content of binder or binders of the layer and/or of the support is preferably at least 2% by weight, but less than 15% by weight, in particular less than 10% by weight, with particular preference from 3 to 6% by weight, based in each case on the total weight of the support and/or of the layer. The anhydrous swollen polymers in particular are used in amounts below 10% by weight, advantageously in amounts of from 4 to 8% by weight, with preference from 5 to 6% by weight.

Preferred binders which can be used alone or in a mixture with other binders are polyethylene glycols, 1,2-polypropylene glycols and also modified polyethylene glycols and polypropylene glycols. The modified polyalkylene glycols include in particular the sulfates and/or the disulfates of polyethylene glycols or polypropylene glycols having a relative molecular mass between 600 and 12 000 and in particular between 1000 and 4000. A further group consists of mono- and/or disuccinates of polyalkylene glycols which in turn have relative molecular masses between 600 and 6000, preferably between 1000 and 4000. For a more precise description of the modified polyalkylene glycol ethers, reference is made to the disclosure of the international patent application WO-A-93/02176. In the context of this invention, the polyethylene glycols include those polymers in whose preparation the start molecules used are not only ethylene glycol but also C₃-C₅ glycols, and glycerol and mixtures thereof. Also included are ethoxylated derivatives such as trimethylolpropane with from 5 to 30 EO.

The polyethylene glycols used with preference may have a linear or branched structure, and preference is given in particular to linear polyethylene glycols.

The especially preferred polyethylene glycols include those having relative molecular masses between 2000 and 12 000, preferably around 4000, for which polyethylene glycols having relative molecular masses below 3500 and above 5000 may be used in particular in combination with polyethylene glycols having a relative molecular mass around 4000 and such combinations advantageously lead to more than 50% by weight, based on the total amount of polyethylene glycols, of polyethylene glycols having a relative molecular mass between 3500 and 5000. However, the binders used may also be polyethylene glycols which themselves are in the liquid state at room temperature and a pressure of 1 bar; this refers in particular to polyethylene glycol having a relative molecular mass of 200, 400 and 600. However, these polyethylene glycols which are themselves liquid should only be used in a mixture with at least one further binder, and this mixture should have a melting point or softening point of at least above 45° C.

The modified polyethylene glycols also include singly or multiply end group-capped polyethylene glycols, and the end groups are preferably C₁-C₁₂-alkyl chains which may be linear or branched. In particular, the end groups have alkyl chains between C₁ and C₆, in particular between C₁ and C₄, although isopropyl and isobutyl or tert-butyl also constitute entirely possible alternatives.

Singly end group-capped polyethylene glycol derivatives may also satisfy the formula Cₓ,(EO)_{y}(PO)_{z}, where Cₓ may be an alkyl chain having a carbon chain length of from 1 to 20, y may be from 50 to 500 and x may be from 0 to 20. For z=0, there exist overlaps with compounds of the preceding paragraph.

However, EO—PO polymers (x is 0) may also serve as binders. Equally suitable as binders are low molecular weight polyvinylpyrrolidones and derivatives thereof having relative molecular masses up to a maximum of 30 000. Preference is given in this context to relative molecular mass ranges between 3000 and 30 000, for example around 10 000. Polyvinylpyrrolidones are preferably not used as the sole binder, but rather in combination with others, in particular in combination with polyethylene glycols.

Suitable further binders have been found to be raw materials which themselves as raw materials have washing or cleaning properties, i.e., for example, nonionic surfactants with melting points of at least 45° C. or mixtures of nonionic surfactants and other binders. The preferred nonionic surfactants include alkoxylated fatty or oxo alcohols, in particular C₁₂-C₁₈ alcohols. Degrees of alkoxylation, especially degrees of ethoxylation, of, on average, from 18 to 100 AO, especially EO, per mole of alcohol and mixtures thereof have been found to be particularly advantageous. In particular, fatty alcohols with, on average, from 18 to 35 EO, in particular with, on average, from 20 to 25 EO, exhibit advantageous binder properties in the context of the present invention. In some cases, binder mixtures may also contain ethoxylated alcohols with, on average, fewer EO units per mole of alcohol, for example tallow fatty alcohol with 14 EO. However, preference is given to using these alcohols with relatively low degrees of ethoxylation only in a mixture with alcohols with higher degrees of ethoxylation. Advantageously, the content of these alcohols with the relatively low degree of ethoxylation in the binders is less than 50% by weight, in particular less than 40% by weight, based on the total amount of binder used. In particular, nonionic surfactants customarily used in laundry detergents and cleaning compositions, such as C₁₂-C₁₈ alcohols with, on average, from 3 to 7 EO which are themselves in liquid form at room temperature, are preferably present in the binder mixtures only in such amounts that less than 10% by weight, in particular less than 8% by weight and advantageously less than 2% by weight, of these nonionic surfactants, in each case based on the process end product, are thus provided. As already described above, it is, however, less preferred to use nonionic surfactants which are liquid at room temperature in the binder mixtures. In a particularly advantageous embodiment, such nonionic surfactants are therefore not a constituent of the binder mixture since they not only lower the softening point of the mixture, but can also contribute to the tackiness of the end product and, moreover, as a result of their tendency to lead to gelation on contact with water, also often do not satisfy the requirement for rapid dissolution of the binder/dividing wall in the end product to the desired degree. It is likewise not preferred that customary anionic surfactants used in washing or cleaning agents, or precursors thereof, the anionic surfactant acids, are present in the binder mixture. C₁₂-C₁₈ fatty alcohols, C₁₆-C₁₈ fatty alcohols or pure C₁₈ fatty alcohol with more than 50 EO, preferably with about 80 EO, by contrast, have been found to be exceptionally suitable binders which can be used alone or in combination with other binders.

Other nonionic surfactants which are suitable as binders are the fatty acid methyl ester ethoxylates which do not tend to gel, in particular those with, on average, from 10 to 25 EO (for a more precise description of this substance group see below). Particularly preferred representatives of this substance group are predominantly methyl esters based on C₁₆-C₁₈ fatty acids, for example hydrogenated beef tallow methyl ester with, on average, 12 EO or with, on average, 20 EO.

A further class of substances which are suitable as binders in the context of the present invention are ethoxylated fatty acids with from 2 to 100 EO, whose “fatty acid” radicals in the context of this invention may be linear or branched. Preference is given in particular to those ethoxylates which have a narrowed homolog distribution (NRE) and/or a melting point above 50° C. Such fatty acid ethoxylates may be used as the sole binder or in combination with other binders, while the nonethoxylated sodium and potassium soaps are less preferred and are used only in combination with other binders.

Likewise suitable are also hydroxy mixed ethers, which can be obtained according to the teaching of European Patent Application EP-A-0 754 667 (BASF) by ring-opening epoxides of unsaturated fatty acid esters, as binders, especially in combination with polyethylene glycols, the aforementioned fatty acid methyl ester ethoxylates or the fatty acid ethoxylates.

Surprisingly, anhydrous swollen polymers, especially starch diphosphate/glycerol, polyvinylpyrrolidone/glycerol and modified cellulose/glycerol, for example hydroxypropylcellulose/glycerol, have been found to be outstandingly useful binders. In this connection from 5 to 20% strength by weight “solutions” of the polymers in glycerol, especially about 10% strength by weight “solutions”, are particularly advantageous.

In a preferred embodiment of the invention, the binder used is a mixture which comprises C₁₂-C₁₈ fatty alcohol based on coconut or tallow with, on average, 20 EO and polyethylene glycol with a relative molecular mass of from 400 to 4000.

In a further preferred embodiment of the invention, the binder used is a mixture which comprises methyl esters based predominantly on C₁₆-C₁₈ fatty acids and having, on average, from 10 to 25 EO, in particular hydrogenated beef tallow methyl ester with, on average, 12 EO or, on average, 20 EO, and a C₁₂-C₁₈ fatty alcohol based on coconut or tallow with, on average, 20 EO and/or polyethylene glycol with a relative molecular mass of from 400 to 4000.

Particularly advantageous embodiments of the invention have been found to be binders which are based either on polyethylene glycol with a relative molecular mass around 4000 alone, or on a mixture of C₁₂-C₁₈ fatty alcohol based on coconut or tallow with, on average, 20 EO and one of the above-described fatty acid methyl ester ethoxylates or on a mixture of C₁₂-C₁₈ fatty alcohol based on coconut or tallow with, on average, 20 EO, one of the abovementioned fatty acid methyl ester ethoxylates and a polyethylene glycol, especially with a relative molecular mass around 4000. In this connection, particular preference is given to mixtures of polyethylene glycol with a relative molecular mass around 4000 with the specified fatty acid methyl ester ethoxylates or with C₁₆-C₁₈ fatty alcohol with 20 EO in a weight ratio of 1:1 or above.

Although other raw materials such as trimethylolpropylene, etc. (commercial products from BASF, Federal Republic of Germany) may be present in binder mixtures, especially in a mixture with polyethylene glycols, they have no disintegrating action.

In addition, further binders which can be used alone or in combination with other binders are also alkyl glycosides of the general formula RO(G)ₓ wherein R is a primary straight-chain or methyl-branched, especially methyl-branched in the 2-position, aliphatic radical having from 8 to 22, preferably from 12 to 18, carbon atoms, and G is the symbol that represents a glycose unit with 5 or 6 carbon atoms, preferably glucose. The degree of oligomerization x which states the distribution of monoglycosides and oligoglycosides is any number between 1 and 10; x is preferably 1.2 to 1.4. Especially suitable alkyl glycosides are those which have a degree of softening above 80° C. and a melting point above 140° C. Likewise suitable are highly concentrated compounds with contents of at least 70% by weight of alkyl glycosides, preferably at least 80% by weight of alkyl glycosides. Using high shear forces, the melt agglomeration and in particular the melt extrusion with compounds highly concentrated in this way can be carried out even at temperatures which are above the softening point, but still below the melting temperature. Although alkyl glycosides can also be used as sole binders, it is preferred to use mixtures of alkyl glycosides and other binders. Especially here mixtures of polyethylene glycols and alkyl glycosides, advantageously in weight ratios of from 25:1 to 1:5, with particular preference from 10:1 to 2:1.

Likewise suitable as binders, especially in combination with polyethylene glycols and/or alkyl glycosides, are polyhydroxy fatty acid amides of the formula (I) wherein R²CO is an aliphatic acyl radical having from 6 to 22 carbon atoms, R³ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups.

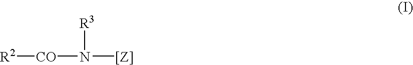

The polyhydroxy fatty acid amides are preferably derived from reducing sugars having 5 or 6 carbon atoms, especially from glucose.

The group of polyhydroxy fatty acid amides also includes compounds of the formula (II)

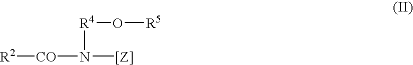

in which R³ is a linear or branched alkyl or alkenyl radical having from 7 to 12 carbon atoms, R⁴ is a linear, branched or cyclic alkyl radical or an aryl radical having from 2 to 8 carbon atoms and R⁵ is a linear, branched or cyclic alkyl radical or an aryl radical or an oxyalkyl radical having from 1 to 8 carbon atoms, preference being given to C₁-C₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical. [Z] is also obtained here preferably by reductive amination of a sugar such as glucose, fructose, maltose, lactose, galactose, mannose or xylose. The N-alkoxy- or N-aryloxy-substituted compounds can be converted to the desired polyhydroxy fatty acid amides according to, for example, the teaching of international patent application WO-A-95/0733 1 by reaction with fatty acid methyl esters in the presence of an alkoxide as a catalyst. Particularly preferred glucamides melt at from just 95 to 105° C. However, here too, as in the case of the alkyl glycosides, working temperatures in the process according to the invention are normally above the softening temperature, but below the melting temperature.

Further Assistants and Additives

Foam inhibitors which can be used in the inventive washing and/or cleaning articles include, for example, soaps, paraffins or silicone oils which may optionally be applied to support materials.

Suitable antiredeposition agents which are also referred to as soil repellents or soil-repellent substances are, for example, nonionic cellulose ethers such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and also the prior art polymers of phthalic acid and/or terephthalic acid and of their derivatives, especially polymers of ethylene terephthalates and/or polyethylene glycol terephthalates or anionically and/or nonionically modified derivatives thereof. Especially preferred among the compounds mentioned are the sulfonated derivatives of phthalic acid and terephthalic acid polymers.

Since sheetlike textile structures, especially composed of Rayon®, viscose staple, cotton and mixtures thereof, can tend to crease because the individual fibers are sensitive toward bending, folding, compressing and crushing transverse to the fiber direction, the inventive washing and/or cleaning articles may comprise synthetic anticrease agents. These include, for example, synthetic products based on fatty acids, fatty acid esters, fatty acid amides, fatty acid alkylol esters, fatty acid alkylol amides or fatty alcohols which have usually been reacted with ethylene oxide, or products based on lecithin or modified phosphoric esters.

To control microorganisms, the inventive washing and/or cleaning articles may comprise antimicrobial substances. A distinction is drawn depending on antimicrobial spectrum and mechanism of action between bacteriostats and bactericides, fungistats and fungicides, etc. Important substances from these groups are, for example, benzalkonium chlorides, alkylarylsulfonates, halophenols and phenylmercuric acetate.

In order to prevent undesired changes to the washing and/or cleaning articles and/or to the textiles treated, caused by the action of oxygen and other oxidative processes, the formulations may comprise antioxidants. This class of compounds includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats which are additionally added to the inventive washing and/or cleaning articles. Antistats increase the surface conductivity and thus enable improved discharge of charges formed. External antistats are generally substances having at least one hydrophilic molecular ligand and impart to the surfaces a more or less hygroscopic film. These usually interface-active antistats can be divided into nitrogen (amines, amides, quaternary ammonium compounds), phosphorus (phosphoric esters) and sulfur (alkylsulfonates, alkyl sulfates) antistats. External antistats have been described, for example, in the patent applications FR 1,156,513, GB 873 214 and GB 839 407. The lauryl- (and stearyl-) dimethylbenzylammonium chlorides disclosed here are suitable as antistats for textiles or as additives to laundry detergents, in which case a hand effect is additionally achieved.

To improve the water absorption capacity or the rewettability of the treated textiles and to ease ironing of the treated textiles, it is possible to use, for example, silicone derivatives in the inventive washing and/or cleaning articles. These additionally improve the rinse-out behavior of the inventive portions by virtue of their foam-inhibiting properties. Preferred silicone derivatives are, for example, polydialkylsiloxanes or alkylaryl siloxanes in which the alkyl groups have from one to five carbon atoms and are fully or partly fluorinated. Preferred silicones are polydimethylsiloxanes which may optionally be derivatized and are in that case amino-functional or quaternized, or have Si—OH, Si—H and/or Si—Cl bonds. The viscosities of the preferred silicones at 25° C. are in the range between 100 and 100 000 mPas, and the silicones may be used in amounts of between 0.2 and 5% by weight, based on the entire washing and/or cleaning article.

Finally, the inventive washing and/or cleaning articles may also comprise UV absorbents which attach to the treated textiles and improve the light stability of the fibers. Compounds which have these desired properties are, for example, the compounds which are active by virtue of radiationless deactivation and derivatives of benzophenone having substituents in the 2- and/or 4-position. Also suitable are substituted benzotriazoles, 3-phenyl-substituted acrylates (cinnamic acid derivatives), optionally having cyano groups in the 2-position, salicylates, organic Ni complexes and also natural products such as umbelliferone and the endogenous urocanic acid.

In order to prevent heavy metal-catalyzed decomposition of certain laundry detergent ingredients, substances may be used which complex the heavy metals. Suitable heavy metal complexing agents are, for example, the alkali metal salts of ethylenediaminetetraacetic acid (EDTA) or of nitrilotriacetic acid (NTA) or of their derivatives, and also alkali metal salts of anionic polyelectrolytes such as polymaleates and polysulfonates.

A preferred class of complexing agents is that of the phosphonates. These preferred compounds include in particular organophosphonates, for example 1-hydroxyethane-1,1-diphosphonic acid (HEDP), aminotri(methylenephosphonic acid) (ATMP), diethylenetriaminepenta(methylenephosphonic acid) (DTPMP or DETPMP) and also 2-phosphonobutane-1,2,4-tricarboxylic acid (PBS-AM) which are usually used in the form of their ammonium or alkali metal salts.

To reduce the pH of laundry detergents or cleaning compositions, especially laundry detergents, the washing and/or cleaning articles may also have acidic salts or slightly alkaline salts. Preferred acidifying components in this context are bisulfates and/or bicarbonates or organic polycarboxylic acids which may simultaneously also be used as builder substances. Preference is given especially to using citric acid.

The present invention further provides a process for producing the inventive washing and/or cleaning article, in which the supports are coated with the single or the multiple substance(s) and/or layers having washing substances by application.

This process comprises substantially the following steps:

unrolling sheetlike structures;

extruding, knifecoating, roll application, scattering-in, casting and/or spraying;

cutting

stamping

conditioning

compressing

packaging,

of which individual or multiple steps may be omitted or repeated.

An essential point in the production of the inventive washing and/or cleaning article is that the layers are not constructed by impregnation, but rather substantially by dry application. The individual layers are compressed by smooth and/or surface-structured rolls and, where necessary, in some cases mixed. Sparingly water-soluble care, washing and/or cleaning substances, for example surfactants, may also be applied in foamed form in the course of the inventive production process. Builders, for example disilicates, may be applied in anhydrous form, i.e. in solid particulate form. These may additionally assume the function of a dessicant, if this is necessary. Bleaches, for example percarbonate, perborate, etc., may likewise be applied as solids. Mutually influencing layers such as percarbonate and surfactants and enzymes may, for example, be protected from one another by film coatings from spray processes. Suitable for this purpose are, for example, PVA (PVA=polyvinyl alcohol) or PVP (PVP=polyvinylpyrrolidone) films which also assume a function in the washing process. However, since the subject matter of the invention concerns solid articles, special protection of substance(s) and/or cleaning substances which are sensitive in aqueous solutions is actually unnecessary.

The present invention finally provides the use of the inventive washing and/or cleaning articles to clean textiles.

In this context, textiles refer to products composed of textile fibers, semifinished and finished textile materials and finished articles produced therefrom, which include not only the clothing industry products refered to colloquially as textiles, but also carpets and other domestic textiles and also textile structures serving industrial purposes. Semifinished and finished textile materials in the context of this standard include unshaped structures such as staples, linear structures such as twine, yarns, lines, laces, cordage, threads, and also sheetlike or three-dimensional structures such as felts, wovens, nonwovens and wadding, and the products produced therefrom.

The washing and/or cleaning article can be used for cleaning hard and/or soft surfaces, preferably textiles, more preferably textiles in washing machines.

For example, the inventive washing and/or cleaning articles may be used in a machine washing, cleaning or care operation. Preference is given to using the inventive washing and/or cleaning articles in commercial washing machines or dishwashers. It is likewise possible to use the inventive washing and/or cleaning articles in handwash basins or in a bowl.

The inventive washing and/or cleaning article may be introduced into the wash or rinse liquor together with the article to be cleaned, such as textile, dishes or the like.

TABLE 4 which follows shows a preferred composition of the inventive washing and/or cleaning article.

The weight data are based on the total weight of the washing and/or cleaning article. In addition, the particular data by weight of the substances are to be selected in such a way that the total weight of the inventive washing and/or cleaning article does not exceed 100% by weight.

The subject matter of the present invention is further illustrated by reference to the example which follows.

### EXAMPLE

TABLE 4 shows the composition of an inventive washing and/or cleaning article.

The textile support material used was a polypropylene nonwoven of basis weight 85 g/m² from Innovatec Kunststoffverarbeitung GmbH & Co. KG. A nonwoven strip of width 90 mm and length 480 mm was placed on a hard substrate. The loose individual components specified in TABLE 5 were scattered onto this strip as will be described.

TABLE 4

| Washing substance/assistant | % by weight |
|---|---|
| Surfactants (total) | 20 |
| Anionic surfactants | 17 |
| Nonionic surfactants | 3 |
| Cationic surfactants | <1 |
| Amphoteric surfactants | <1 |
| Gemini surfactants | <1 |
| Enzymes | 1.7 |
| Builders | 20-25 |
| Bleaches | 15-20 |
| Bleach activators | 6 |
| Color transfer inhibitors¹ | 0.6 |
| Graying inhibitors | 0.6 |
| Soil-repellent substances | 1 |
| Optical brighteners | 1 |
| Fragrances | 0.4 |
| Fabric softeners | <1 |
| Disintegration assistants | 20 |
| Dyes | 0.01 |

Color transfer inhibitors¹ = polyvinylpyrrolidone

In the last step, the nonwoven strips were cut to the width of the extrudate strips and the complete strips were divided into four dose units of 75 g.

The lower, middle and upper layer specified in TABLE 5 were extruded using an extruder having a slot-shaped die attachment. The layer thickness of the upper and lower layer was 2.2 mm, the layer thickness of the middle layer was 1.6 mm. The strips had a width of 70 mm. The lower layer was placed on the nonwoven strip on which the components had been scattered and the individual components (=substances) were incorporated by rolling with a hand roll. Subsequently, the middle and upper layer were produced, placed on the lower layer and covered with a second nonwoven strip. The structure was again rolled with a compressive force of 100 N in order to increase the adhesion of the layers.

TABLE 5

| | | % by |
|---|---|---|
| | Components | weight |
| Individual | NaHCO3 | 4 |
| components | Soil release polymer: preparation of polyethylene | 1 |
| | glycol/polyester and sodium sulfate | |
| | Foam inhibitor concentrate: 1-5% nonionic | 4 |
| | surfactants, >20% sodium carbonate | |
| | Quadrozym ACL 9: preparation of protease, | 2 |
| | amylase, cellulase and | |
| | ABS-CA5 compound: | 1.5 |
| | Σ | 12.5 |
| Lower | Sodium acetate | 8 |
| layer | Tower powder: 20-25% ABS, >30% sodium | 18 |
| | carbonate, 10-15% waterglass, 10-15% sulfate, | |
| | 5-10% polymeric cobuilder, remainder | |
| | Sulfopon mix: >60% anionic surfactants, 1-5% | 3 |
| | sodium carbonate | |
| | Sodium citrate | 1 |
| | C12-18 fatty alcohol with 7 EO | 2 |
| | Polyethylene glycols, average molar mass of 4000 | 1 |
| | Σ | 33 |
| Middle | Percarbonate | 14 |
| layer | Polyvinylcaprolactam | 0.5 |
| | Polyethylene glycols, average molar mass of 4000 | 0.5 |
| | Tetraacetylethylene diamines | 5.0 |
| | Sodium silicate, molar ratio 2.0 | 3 |
| | Σ | 23 |
| Upper | Sodium acetate | 11 |
| layer | Tower powder: 20-25% ABS, >30% sodium | 14 |
| | carbonate, 10-15% waterglass, 10-15% sulfate, | |
| | 5-10% polymeric cobuilder, remainder | |
| | Sulfopon mix 3: >60% anionic surfactants, 1-5% | 3 |
| | sodium carbonate | |
| | Sodium citrate | 0.5 |
| | C12-18 fatty alcohol with 7 EO | 2 |
| | Polyethylene glycols, average molar mass of 4000 | 1 |
| | Σ | 31.5 |

The weight data are based on the total weight of the layers without nonwoven strips.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

What is claimed is:

1. A washing and/or cleaning article, comprising:
a support having at least one care, washing and/or cleaning substance disposed thereupon, wherein said article is reversibly bendable.

2. The article of claim 1, wherein the article is dimensionally stable.

3. The article of claim 1, wherein the article has a modulus of elasticity at 20° C. of ≧100 MPa.

4. The article of claim 1, wherein the article, on cessation of the action of a reshaping force, has a rebound rate v of ≧1000 mm/min.

5. The article of claim 1, wherein the care, washing and/or cleaning substance is part of a layer attached to the support.

6. The article of claim 5, further comprising a second layer including a care, washing and/or cleaning substance.

7. The article of claim 6, wherein the second layer is separate from the first layer.

8. The article of claim 6, further comprising a third layer including a care, washing and/or cleaning substance.

9. The article of claim 1, further comprising a second support, with a plurality of layers disposed therebetween, each layer containing at least one care, washing and/or cleaning substance.

10. The article of claim 9, wherein mutually influencing layers are protected from one other.

11. The article of claim 1, wherein the care, washing and/or cleaning substance is independently selected from the group consisting of anionic surfactants, nonionic surfactants, cationic surfactants, amphoteric surfactants, amino acids, alkyl-substituted amino acids, acylated amino acids, gemini surfactants, disintegration assistants, enzymes, builders, cobuilders, bleaches, bleach activators, bleach stabilizers, bleach catalysts, polymers, fabric softeners, rinse aids, alkalizing agents, acidifying agents, antiredeposition agents, color transfer inhibitors, silver protectants, graying inhibitors, soil-repellent substances, optical brighteners, antimicrobial substances, fragrances, perfumes, dyes, UV protection substances, assistants and additives, anticrease agents, foam inhibitors, antioxidants, antistats, substances for improving the rewettability, UV absorbents, complexing agents, agents for adjusting the pH, and enzyme stabilizers.

12. The article of claim 1, wherein the support is selected from at least one of the group consisting of foams, open-pore foams, synthetic fibers, natural fibers, microfibers, nanofibers, hollow fibers, solid fibers, nonwoven fabrics, woven fabrics, films, and knits.

13. The article of claim 1, further comprising a second support.

14. The article of claim 1, wherein the second support is of a water-soluble material.

15. The article of claim 1, further comprising:
at least one layer containing bleach;
at least one layer containing builders or surfactants; and
at least one layer containing enzymes.

16. The article of claim 1, wherein the care, washing and/or cleaning substance is in granule form.

17. The article of claim 1, wherein the care, washing and/or cleaning substance is embedded.

18. The article of claim 1, further comprising a solubility improver.

19. The article of claim 1, further comprising a plasticizing assistant.

20. The article of claim 1, further comprising polyacrylate as an additive whose volume increases under wash conditions.

21. The article of claim 1, wherein the article has a weight of between 40 g and 85 g.

22. The article of claim 1, wherein ≧80% by weight of the article is dispersed in water at ≧30°C. in ≦10 min.

23. The article of claim 1, wherein 90% of the water-soluble components in the article have dissolved in water at ≧30° C. in ≦10 min.

24. The article of claim 1, wherein the water soluble compoarticle disintegrates in water at ≧30° C. in ≦5 min.

25. A method of laundering, comprising:
providing a washing and/or cleaning article, comprising a first support and second support with a plurality of layers disposed therebetween, each layer containing at least one care, washing and/or cleaning substance, wherein mutually influencing layers are protected from one other; and
placing the article in a washing machine.
